(19) United States
(12) Patent Application Publication
(10) Pub. No.: US 2018/0121610 A1
(43) Pub. Date: May 3, 2018

(54) SELECTING A HEALTHCARE DATA PROCESSING APPROACH

(71) Applicant: Always in Touch, Inc., Milwaukee, WI (US)

(72) Inventors: Marc Lawrence Cayle, Mequon, WI (US); Tyler James Hackbarth, Milwaukee, WI (US); Keenan Phillip Nemetz, Milwaukee, WI (US); Erich K. Jacobs, Lexington, MA (US); Gary W. Grube, Barrington Hills, IL (US)

(73) Assignee: Always in Touch, Inc., Milwaukee, WI (US)

(21) Appl. No.: 15/793,165

(22) Filed: Oct. 25, 2017

Related U.S. Application Data
(60) Provisional application No. 62/414,135, filed on Oct. 28, 2016.

(51) Int. Cl. G06F 19/00

(52) U.S. Cl. CPC G06F 19/322; G06F 19/324

(57) ABSTRACT

A method for selecting a healthcare data processing approach includes a computing device receiving healthcare data from one or more data source devices, selecting one or more context inputs of a plurality of input sources, obtaining the one or more context inputs, and determining the healthcare data processing approach based on one or more of the healthcare data, configuration information, and an interpretation of the one or more context inputs. The method further includes the computing device applying the healthcare data processing approach to the healthcare data to produce a representation of the healthcare data that includes at least one of a transformation of the healthcare data and an interpretation of the healthcare data when a regulatory aspect of the configuration information allows the computing device to represent the healthcare data in a format other than as received from the one or more data source devices.

### CROSS REFERENCE TO RELATED PATENTS

The present U.S. Utility Patent Application claims priority pursuant to 35 U.S.C. § 119(e) to U.S. Provisional Application No. 62/414,135, entitled “PROCESSING MEDICAL DEVICE DATA WITH REGULATORY COMPLIANCE,” filed Oct. 28, 2016, which is hereby incorporated herein by reference in its entirety and made part of the present U.S. Utility Patent Application for all purposes.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Technical Field of the Invention

This invention relates generally to computer networks and more particularly to medical device data systems.

### Description of Related Art

The use of medical devices is well known. Medical devices are known to include apparatus and software used for diagnostic and treatment purposes for human beings. Examples include a body temperature medical device, a heart rate medical device, a heart rhythm medical device, and a blood pressure medical device. It is further known that the medical devices are typically utilized in a clinical environment where medical professionals directly operate the medical devices in the diagnosis and treatment of human patients. For example, a heart rhythm medical device is utilized in a hospital setting by a medical professional to evaluate a patient heart rhythm. It is also known that governmental regulatory bodies impose guidelines, restrictions, and requirements regarding the use of medical devices with the human patients and provide approvals when the medical devices have met the associated requirements. It is also known that the regulatory requirements may change from time to time as technology advances and experience curves indicate viable utility of such regulatory oversight.

Remote use of medical devices is known to help achieve lower overall healthcare costs. Remote utilization of medical devices includes real-time, near real-time, and non-real-time processing of medical device data. For example, in a real-time scenario, each of 12 beds in a hospital wing are equipped with heart rhythm medical device monitors that forward monitored heart rhythm data in real-time to a closed centralized nursing station where one on-duty nurse is available to react to any unfavorably detected heart rate information. Such real-time processing of medical device data is generally subject to more restrictive governmental regulatory body rules. Developing products to meet stricter government restrictions is known to take longer at higher costs.

Medical device data systems (MDDS) are known to include hardware and software products that transfer, store, convert formats, and display medical device data without modifying the data and without modifying control functions of a medical device where the medical device data system is not intended to be used for active patient monitoring. For example, a computing system that converts data of an electrocardiogram into a format that can be displayed and printed. As another example, a computing system that stores blood pressure readings for remote access at a later time. Products and solutions aligned with medical device data systems that do not modify the data are generally associated with less restrictive governmental regulatory body rules.

The Internet of things (IoT) is known to include an interworking of smart devices (e.g., computers, sensors, actuators) that enables the smart devices to collect and exchange data across existing network infrastructure to further integrate physical world entities of the smart devices into computer systems to provide benefit (e.g., lower costs, more efficiency, more accuracy, etc.). IoT example smart devices include smart thermostats networked with heating and air-conditioning systems, refrigerators that sense content and automatically order replacement food items, lighting systems that detect actual need and adjust lighting levels to reduce costs, and home environmental monitors that monitor and report flooding, smoke, and fire. Internet of things systems may include tens, hundreds, and even thousands of smart devices within a common physical area. Communication of information from thousands of co-located smart devices is known to be challenging from an organization perspective and physical communication perspective.

### BRIEF DESCRIPTION OF THE SEVERAL VIEWS OF THE DRAWING(S)

FIG. 1 is a schematic block diagram of an embodiment of a medical device data system (MDDS) in accordance with the present invention;

FIG. 2 is a schematic block diagram of an embodiment of user device of a medical device data system in accordance with the present invention;

FIG. 3 is a schematic block diagram of an embodiment of facility device of a medical device data system in accordance with the present invention;

FIG. 4 is a schematic block diagram of an embodiment of wireless medical device of a medical device data system in accordance with the present invention;

FIG. 5 is a schematic block diagram of an embodiment of wireless internet of things (IoT) device of a medical device data system in accordance with the present invention;

FIG. 6 is a schematic block diagram of an embodiment of control server of a medical device data system in accordance with the present invention;

FIGS. 7A, 7B, and 7C are schematic block diagrams of other embodiments of a medical device data system (MDDS) in accordance with the present invention;

FIG. 8A is a schematic block diagram of another embodiment of a medical device data system (MDDS) in accordance with the present invention;

FIG. 8B is a logic diagram of an embodiment of a method for establishing configuration information in accordance with the present invention;

FIGS. 9A, 9B, and 9C are schematic block diagrams of another embodiment of a medical device data system (MDDS) in accordance with the present invention;

FIG. 9D is a logic diagram of an embodiment of a method for escalating an alert in accordance with the present invention;

FIG. 10A is a schematic block diagram of another embodiment of a medical device data system (MDDS) in accordance with the present invention;

FIG. 10B is a logic diagram of an embodiment of a method for distributing data in accordance with the present invention;

FIG. 11A is a schematic block diagram of another embodiment of a medical device data system (MDDS) in accordance with the present invention;

FIG. 11B is a logic diagram of an embodiment of a method for detecting a state trigger in accordance with the present invention;

FIG. 12A is a schematic block diagram of another embodiment of a medical device data system (MDDS) in accordance with the present invention;

FIG. 12B is a logic diagram of an embodiment of a method for affiliating a plurality of facility devices in accordance with the present invention;

FIG. 13A is a schematic block diagram of another embodiment of a medical device data system (MDDS) in accordance with the present invention;

FIG. 13B is a logic diagram of an embodiment of a method for sharing data distribution tasks in accordance with the present invention;

FIG. 14A is a schematic block diagram of another embodiment of a medical device data system (MDDS) in accordance with the present invention;

FIG. 14B is a logic diagram of an embodiment of a method for sharing of healthcare data in accordance with the present invention;

FIG. 15A is a schematic block diagram of another embodiment of a medical device data system (MDDS) in accordance with the present invention;

FIG. 15B is a logic diagram of an embodiment of a method for updating configuration information in accordance with the present invention;

FIG. 16A is a schematic block diagram of another embodiment of a medical device data system (MDDS) in accordance with the present invention;

FIG. 16B is a logic diagram of an embodiment of a method for updating software in accordance with the present invention;

FIG. 17A is a schematic block diagram of another embodiment of a medical device data system (MDDS) in accordance with the present invention;

FIG. 17B is a logic diagram of an embodiment of a method for selecting a communication path in accordance with the present invention;

FIGS. 18A-18C are schematic block diagrams of another embodiment of a medical device data system (MDDS) in accordance with the present invention;

FIG. 18D is a logic diagram of an embodiment of a method for selecting a healthcare data processing approach in accordance with the present invention;

FIG. 19A is a schematic block diagram of another embodiment of a medical device data system (MDDS) in accordance with the present invention; and

FIG. 19B is a logic diagram of an embodiment of a method for processing healthcare data in accordance with the present invention.

### DETAILED DESCRIPTION OF THE INVENTION

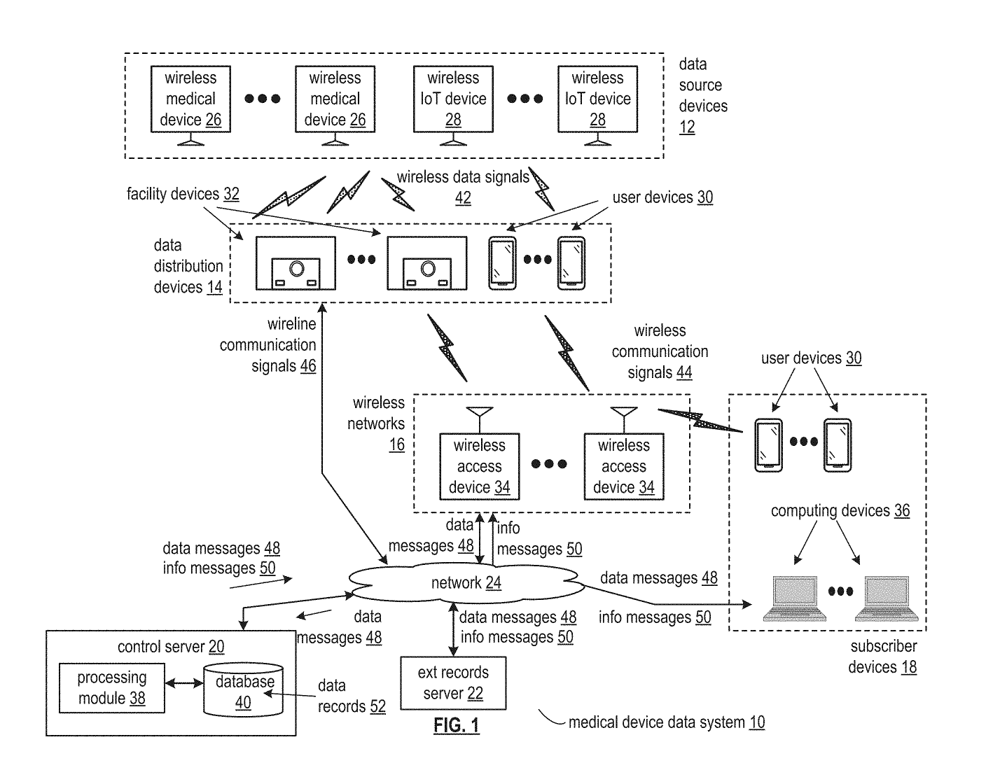

FIG. 1 is a schematic block diagram of an embodiment of a medical device data system (MDDS) 10 that includes data source devices 12, data distribution devices 14, wireless network 16, subscriber devices 18, one or more networks 24, one or more control servers 20, and one or more external (EXT) records servers 22. Hereafter, the medical device data system 10 may be interchangeably referred to as a medical network, a system, a communication system, a data communication system, and a communication network.

Each data source device 12, data distribution device 14, subscriber device 18, control server 20, and external records server 22 is a computing device that includes a computing core. In general, a computing device is any electronic device that can communicate data, process data, and/or store data. A further generality of a computing device is that it includes a central processing unit (CPU), a memory system, user input/output interfaces, peripheral device interfaces, and an interconnecting bus structure.

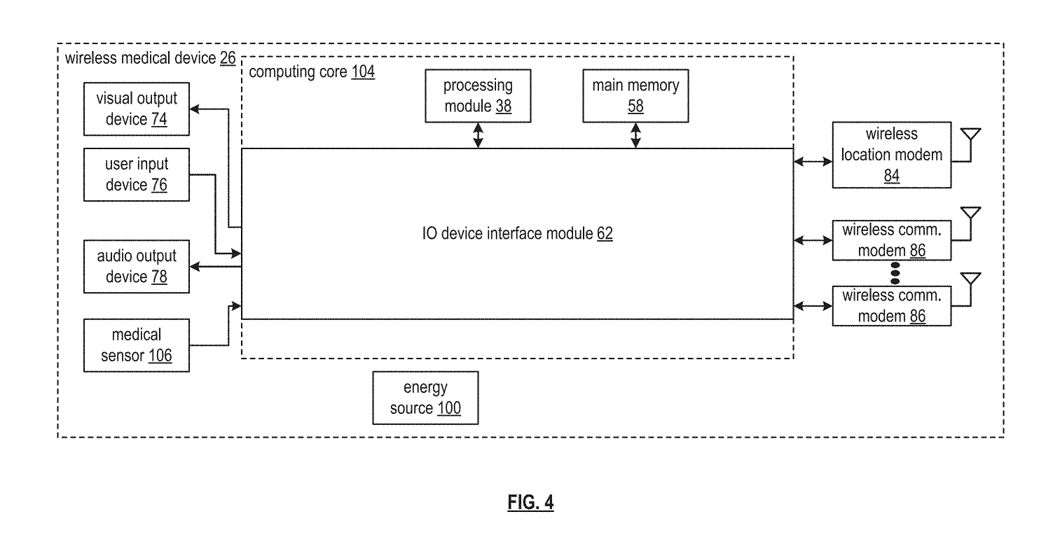

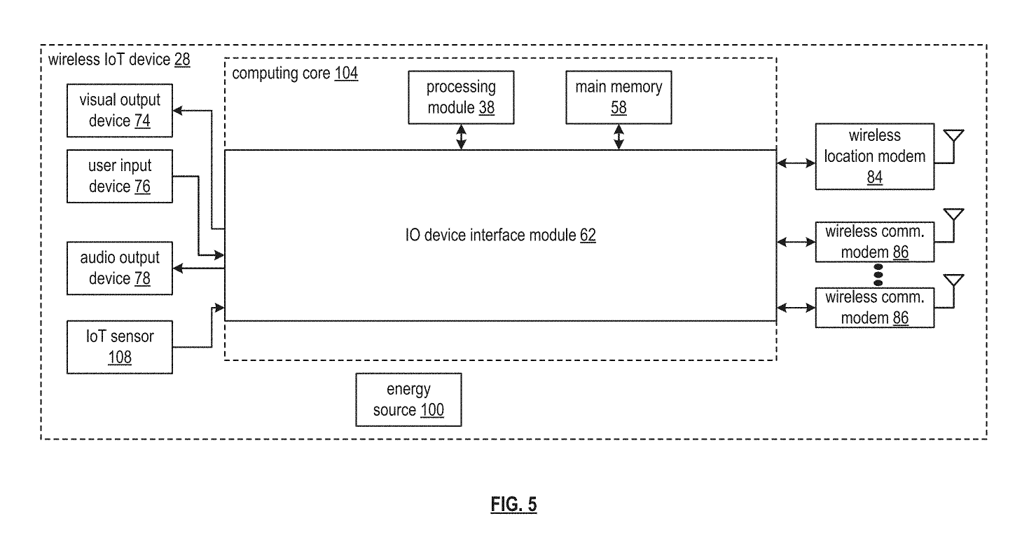

The data source devices 12 includes one or more wireless medical devices 26 and one or more wireless Internet of things (IoT) devices 28. Each wireless medical device 26 provides medical device data with regards to a medical sensor within a local environment. Examples of the medical data includes body temperature data, blood pressure data, heart rate data, heart rhythm data, blood glucose data, etc. An embodiment of the medical device 26 is discussed in greater detail with reference to FIG. 4. Each Internet of things device 28 provides IoT device data and data connectivity with regards to an object within the local environment. Examples of the device data include temperature sensor data, smoke detector data, intrusion detector data, image sensor data, microphone data, motion sensing data, etc. An embodiment of the IoT device 28 is discussed in greater detail with reference to FIG. 5.

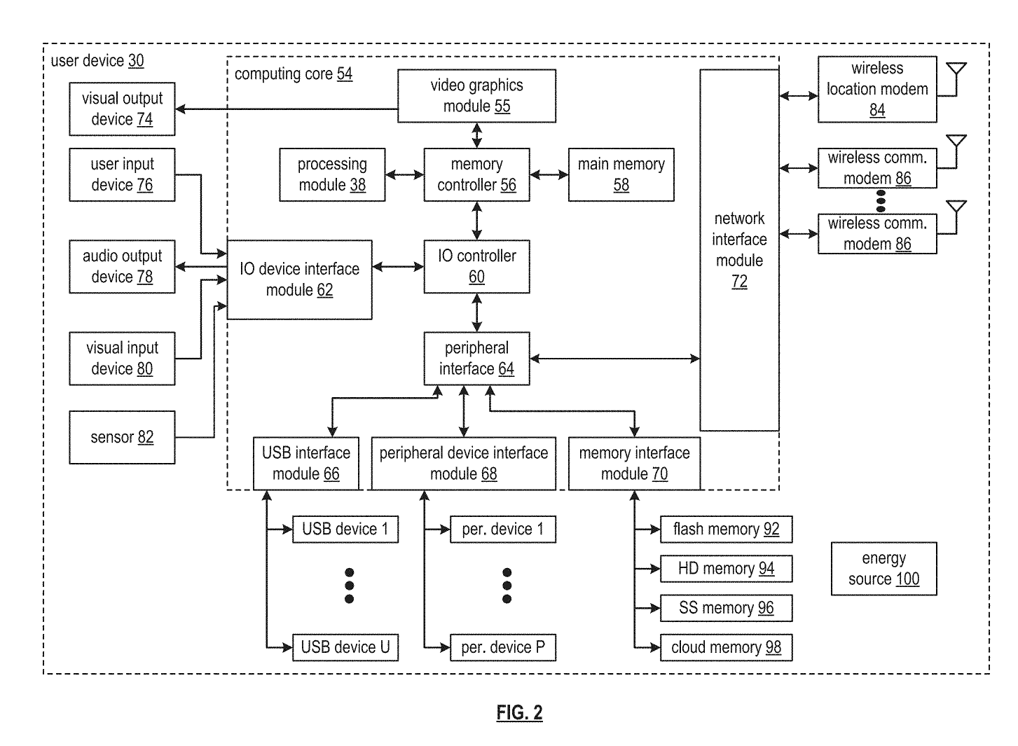

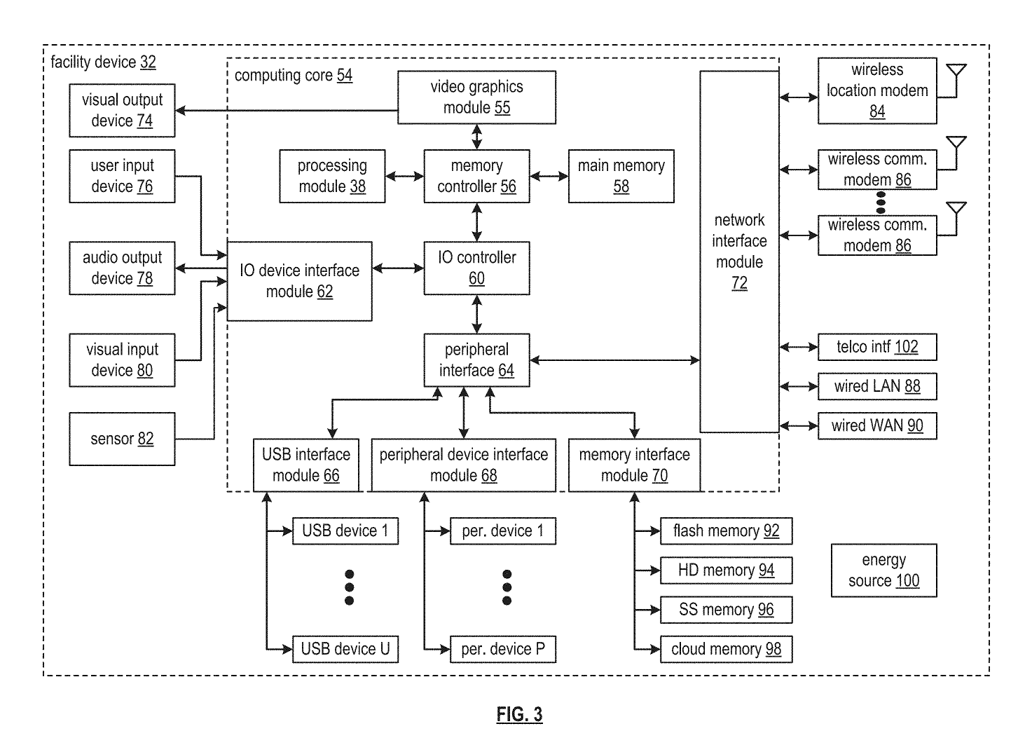

The data distribution devices 14 includes one or more facility devices 32 and one or more user devices 30. Each facility device is associated with at least a portion of a facility (e.g., a home, an assisted living center, a hospital, a hotel, an office, etc.). An embodiment of the facility device 32 is discussed in greater detail with reference to FIG. 3. Each user device 30 may be implemented utilizing a portable computing device which may not be associated with a particular facility. An embodiment of the user device 30 is discussed in greater detail with reference to FIG. 2.

The wireless network 16 includes a plurality of wireless access devices 34. Each wireless access device 34 functions to communicate wireless communication signals 44 in accordance with one or more wireless standards (e.g., cellular, Wi-Fi, Bluetooth, ZigBee, etc.). For example, a plurality of cellular wireless access devices 34 provide a cellular network. As another example, the wireless access devices 34 provide Wi-Fi access points within wireless communication range of the data distribution devices 14.

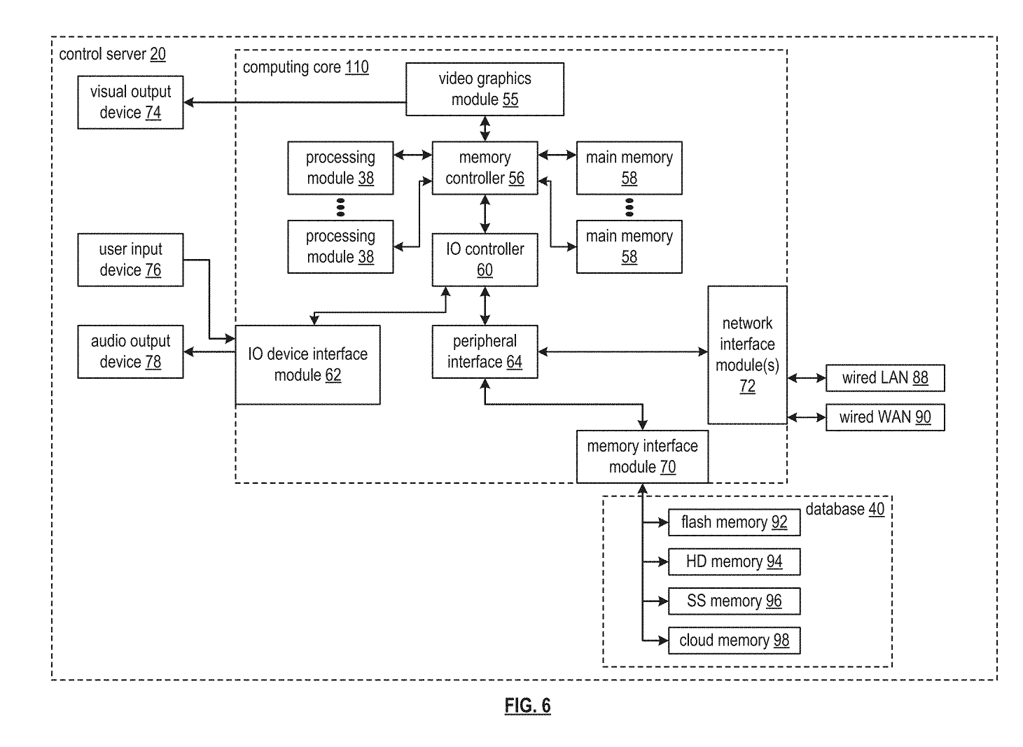

The subscriber devices 18 includes one or more user devices 30 (e.g., a smart phone) and one or more computing devices 36 (e.g., a laptop). The control server 20 includes a processing module 38 and a database 40. The database 40 stores data records 52. Examples of data records 52 includes user account information (e.g., identifiers, permissions, affinity relationships of individuals and groups, privacy requirements, etc.), and configuration information. The configuration information includes data source device configuration information and data distribution device configuration information. The data source device configuration information includes one or more of data type, sensor type, security information, regulatory information, device identifiers, communication path identifiers, etc. The data distribution device configuration information includes one or more of a data distribution approach, alert escalation information, identifiers of alert recipients, identifiers of data recipients, identifiers of information recipients, data manipulation regulatory information, data transfer regulatory information, etc. An embodiment of the control server 20 is discussed in greater detail with reference to FIG. 6.

The external records server 22 may also include the processing module 38 and the database 40. The network 24 may include one or more wireless and/or wire lined communication systems; one or more private intranet systems and/or public internet systems; and/or one or more local area networks (LAN) and/or wide area networks (WAN).

As further specific examples, each of the user devices 30, the facility devices 32, and the computing devices 36 may be a portable computing device and/or a fixed computing device. A portable computing device may be a social networking device, a gaming device, a cell phone, a smart phone, a personal digital assistant, a digital music player, a digital video player, a laptop computer, a handheld computer, a tablet, a video game controller, and/or any other portable device that includes a computing core. A fixed computing device may be a personal computer (PC), a computer server, a cable set-top box, a satellite receiver, a television set, a printer, a fax machine, home entertainment equipment, a video game console, and/or any type of home or office computing equipment that includes a computing core.

The medical device data system (MDDS) 10 supports the exchange and processing of the medical device data and the IoT device data, where the exchange and processing of the medical device data may be in accordance with governmental regulatory requirements. In support of the exchanging and processing of the data (e.g., medical device data, IoT device data), the control server 20 issues, via the network 24, information messages 50 to the data distribution devices 14 to establish and/or update configuration of the facility devices 32 and the user devices 30. The information messages 50 includes one or more of configuration information, software updates, a representation of data, process data, control information, and interpretation of data, and regulatory requirements. For example, the processing module 38 retrieves data records 52 from the database 40, where the data records 52 includes the configuration information. Having retrieved the configuration information, the processing module 38 generates the information messages 50 to include the configuration information and sends, via the network 24, the information messages 50 to the facility devices 32 and the user devices 30. The sending may further include encoding the configuration information to produce wireline communication signals in accordance with one or more wireline standards and facilitating transmission of the wireline communication signals 46 from the network 24 directly to one of the facility devices 32. The sending may still further include facilitate sending of the information messages 50 via one or more of the wireless access devices 34 utilizing wireless communication signals 44 to the facility devices 32 and the user devices 30. Having received the configuration information, the facility devices 32 and user devices 30 utilize the configuration information with regards to the exchanging and processing of the data.

In support of the exchange and processing of the data, a data distribution device 14 obtains the medical device data and the IoT device data via wireless data signals 42 from the data source devices 12 in accordance with the configuration information (e.g., which device, what type of data, etc.), where the wireless data signals 42 include data that has been encoded to produce the wireless data signals 42 in accordance with one or more wireless standards (e.g., ZigBee, Wi-Fi, Bluetooth, etc.). Alternatively, the wireless medical device 26 and the wireless IoT device 28 may utilize a wireline communication path to be operably coupled to the data distribution devices 14. For example, the facility device 32 receives the wireless data signal 42, and decodes the wireless data signal 42 to reproduce the medical device data, where the wireless medical device 26 encodes the medical device data into the wireless data signal 42 and transmits the wireless data signal 42 to the facility device 32. As another example, the user device 30 of the data distribution devices 14 receives the wireless data signal 42, and decodes the wireless data signal 42 to reproduce the IoT device data, where the wireless IoT device 28 encodes the IoT device data into the wireless data signal 42 and transmits the wireless data signal 42 to the user device 30.

Having obtained the medical device data and the IoT device data, the data distribution device 14 processes the data in accordance with the configuration information. The processing of received data includes one or more of generating a representation of the data, detecting of an attribute associated with the data, indicating of the attribute, and sending the representation of the data to a recipient. The generating of the representation includes one or more of converting the data from one format to another, selecting a portion of the data, generating a data summary related to the data, and generating an alert based on the data and in particular the detecting of the attribute associated with the data. The detecting of the attribute associated with the data includes one or more of comparing one or more values of the data associated with at least one time frame to a predetermined pattern to detect an alert trigger, validating the data, receiving local data (e.g., from a sensor and/or user input of the data distribution is 14), and generating an alert based on the detected alert trigger. Alternatively, the detecting of the trigger may include verifying a plurality of conditions associated with a state of a plurality of possible state permutations, where the conditions includes a time range, a data value range, a local user input (e.g., of the data distribution device 14), and a local sensor input (e.g., of the data distribution device 14). The generating of the alert includes one or more of indicating a data value, indicating a datatype, indicating alert type, and indicating a data source. For example, a schedule non-compliancy alert is generated when detecting a schedule adherence error with regards to a user input (e.g., a push button signal is not received within an expected time frame).

The sending of the representation of the data to the recipient includes selecting one or more recipients, selecting one or more communication paths (e.g., wireline, wireless), and sending the representation of the data via the selected one or more communication paths to the selected one or more recipients. The selecting of the one or more recipients includes identifying of the one or more recipients based on one or more of the configuration information, interpreting a query response, and receiving a request. The recipients include one or more of the facility device 32, the user device 30, the computing device 36, the external record server 22, and the control server 20. The selecting of the one or more communication paths includes determining a communication path requirement, obtaining communication path performance levels, and selecting the communication path based on the requirements and the performance levels.

In an example of operation of the processing of the data in accordance with the configuration information, the facility device 32 interprets the configuration information and converts the medical device data from a received format to a second format compatible with the user device 30 of the subscriber devices 18 to produce a data message 48 in accordance as specified by the configuration information, selects wireless communication signals 44 (e.g., a text message service when the wireless network 16 includes a cellular network) as the communication path from the facility device 32 to the user device 30, generates the wireless communication signals 44 to include the data messages 48, facilitates transmission of the wireless communication signals 44 to the user device 30 via one or more of the wireless access devices 34, where the user device 30 displays the second format medical device data, and facilitates transmission of the data message 48 via the wireline communication signals 46 to the external records server 22 via the network 24 when the configuration information includes sending of the medical device data to the external records server 22 for long-term storage. The data message 48 may include the medical device data and/or the IoT device data. Alternatively, the facility device 32 sends the data message 48 via the wireless communication signals 44 through the wireless access device 34 to the external records server 22 via the network 24.

In another example of the processing of the data in accordance with the configuration information, the facility device 32 detects a schedule noncompliance trigger associated with a user of the facility device 32 (e.g., the user to activate a user input within an expected time frame), identifies a particular wireless medical device 26 associated with a state when the schedule noncompliance trigger has occurred, obtains, via the wireless data signals 42, medical device data from the identified wireless medical device 26, transforms the medical device data in accordance with the configuration information to produce a representation of the medical device data, identifies a recipient computing device 36 from the configuration information, generates a data message 48 that includes the representation of the medical device data and an alert associated with the trigger, and sends, via the network 24, the data message 48 to the computing device 36. When confirmation of receipt of the data message 48 by the computing device 36 is not received within a response time frame, the facility device 32 identifies a user device 30 of the subscriber devices 18 as a next recipient in accordance with an alert escalation approach. Having identified the user device 30, the facility device 32 to facilitates sending the data message 48 to the identified user device 30. Such a method may repeat until an acknowledgment indicates successful communication of the data message 48 to the recipient.

FIG. 2 is a schematic block diagram of an embodiment of the user device 30 of the medical device data system (MDDS) 10 of FIG. 1. The user device 30 includes a computing core 54, one or more visual output devices 74 (e.g., video graphics display, touchscreen, LED, etc.), one or more user input devices 76 (e.g., keypad, keyboard, touchscreen, voice to text, a push button, a microphone, etc.), one or more audio output devices 78 (e.g., speaker(s), headphone jack, a motor, etc.), one or more visual input devices 80 (e.g., camera, photocell, etc.), one or more sensors 82 (e.g., accelerometer, velocity, compass, motion, gyro, temperature, pressure, altitude, humidity, moisture, image, biometric, infrared, rater, ultrasonic, proximity, magnetic field, biomaterial, radiation, weight, density, chemical, fluid flow volume, DNA, wind speed, wind direction, object detection, object identifier, medical, motion recognition, and battery level), one or more universal serial bus (USB) devices (USB devices 1-U), one or more peripheral devices (e.g., peripheral devices 1-P), one or more memory devices (e.g., a flash memory device 92, one or more hard drive (HD) memories 94, one or more solid state (SS) memory devices 96, and/or cloud memory 98), one or more wireless location modems 84 (e.g., GPS, Wi-Fi, angle of arrival, time difference of arrival, signal strength, dedicated wireless location, etc.), one or more wireless communication modems 86 (e.g., a cellular telephone transceiver, a wireless data network transceiver, a Wi-Fi transceiver, a Bluetooth transceiver, a 315 MHz transceiver, a zig bee transceiver, etc.), and an energy source 100 (e.g., a battery, a solar cell, a fuel cell, a capacitor, a generator, etc.).

The computing core 54 includes a video graphics module 55, one or more processing modules 38, a memory controller 56, main memory 58 (e.g., RAM), one or more input/output (I/O) device interface modules 62, an input/output (I/O) controller 60, a peripheral interface 64, one or more USB interface modules 66, one or more network interface modules 72, one or more memory interface modules 70, and/or one or more peripheral device interface modules 68. Each of the interface modules 62, 66, 68, 70, and 72 includes a combination of hardware (e.g., connectors, wiring, etc.) and operational instructions stored on memory (e.g., driver software) that is executed by the processing module 38 and/or a processing circuit within the interface module. Each of the interface modules couples to one or more components of the user device 30. For example, one of the IO device interface modules 62 couples to an audio output device 78. As another example, one of the memory interface modules 70 couples to flash memory 92 and another one of the memory interface modules 70 couples to cloud memory 98 (e.g., an on-line storage system and/or on-line backup system).

FIG. 3 is a schematic block diagram of an embodiment of the facility device 32 of the medical device data system (MDDS) 10 of FIG. 1. In addition to the modules and devices of the user device 30 discussed in FIG. 2, the facility device 32 includes a telco interface 102, a wired local area network (LAN) 88, and a wired wide area network (WAN) 90. The telco interface 102 interfaces to a public switched telephone network.

FIG. 4 is a schematic block diagram of an embodiment of the wireless medical device 26 of the medical device data system (MDDS) 10 of FIG. 1. The wireless medical device 26 includes the visual output device 74 of FIG. 2, the user input device 76 of FIG. 2, the audio output device 78 of FIG. 2, a medical sensor 106 (e.g., a pulse rate monitor, a heart rhythm monitor, a breathing detector, a blood pressure monitor, a blood glucose level detector, an electrocardiogram sensor, a body mass detector, an imaging sensor, a microphone, a temperature detector, etc.), a computing core 104, the wireless location modem 84 of FIG. 2, one or more wireless communication modems 86 of FIG. 2, and the energy source 100 of FIG. 2. The computing core 104 includes the processing module 38 of FIG. 2, the main memory 58 of FIG. 2, and the input output (I/O) device interface module 62 of FIG. 2.

FIG. 5 is a schematic block diagram of an embodiment of the wireless Internet of things (IoT) device 28 of the medical device data system (MDDS) 10 of FIG. 1. The wireless IoT device 28 includes the visual output device 74 of FIG. 2, the user input device 76 of FIG. 2, the audio output device 78 of FIG. 2, an IoT sensor 108 (e.g., a room temperature sensor, an image sensor, a sound detector, a microphone, a smoke detector, an intrusion detector, a motion detector, a door position sensor, a window position sensor, a sunlight detector, etc.), the computing core 104 of FIG. 4, the wireless location modem 84 of FIG. 2, one or more wireless communication modems 86 of FIG. 2, and the energy source 100 of FIG. 2. The computing core 104 includes the processing module 38 of FIG. 2, the main memory 58 of FIG. 2, and the input output (I/O) device interface module 62 of FIG. 2.

FIG. 6 is a schematic block diagram of an embodiment of the control server 20 of the medical device data system (MDDS) 10 of FIG. 1. The control server 20 includes a computing core 110, one or more visual output devices 74 of FIG. 2, one or more user input devices 76 of FIG. 2, one or more audio output device 78 of FIG. 2, the wired LAN 88 of FIG. 3, the wired WAN 90 of FIG. 3, and the database 40 of FIG. 1. The computing core 110 includes the video graphics module 55 of FIG. 2, the memory controller 56 of FIG. 2, a plurality of processing modules 38 of FIG. 2, a plurality of main memories 58 of FIG. 2, the input output (I/O) controller 60 FIG. 2, the I/O device interface module 62 of FIG. 2, the peripheral interface 64 of FIG. 2, the memory interface module 70 of FIG. 2, and the network interface modules 72 of FIG. 2. The database 40 may include one or more of the flash memory 92 of FIG. 2, the hard drive (HD) memory 94 of FIG. 2, the solid-state (SS) memory 96 of FIG. 2, and the cloud memory 98 of FIG. 2. In other embodiments, the control server 20 may include more or less devices and modules than shown in this example embodiment of a server.

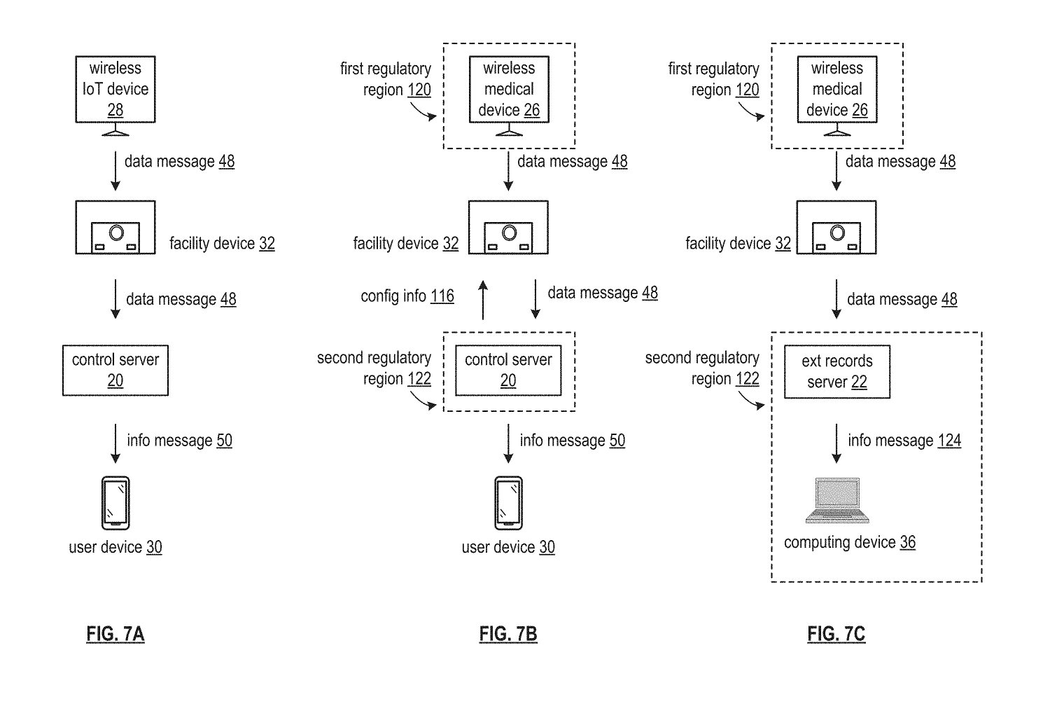

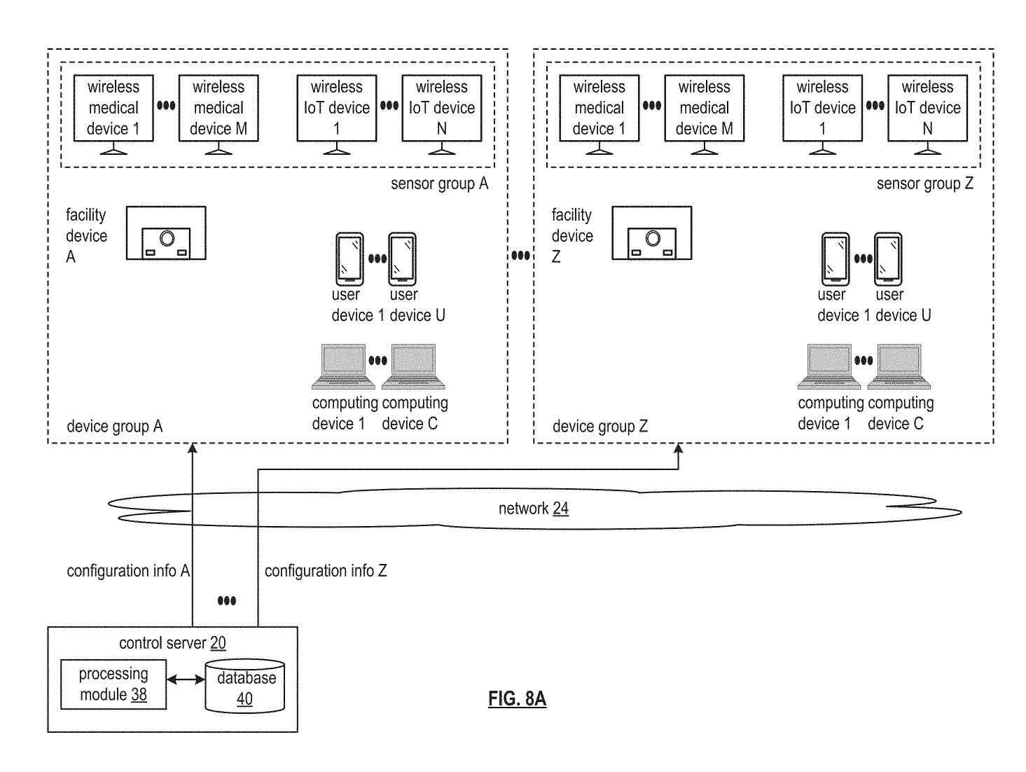

FIGS. 7A, 7B, and 7C are schematic block diagrams of other embodiments of the medical device data system (MDDS) 10, where the MDDS functions in accordance with regulatory regions. Each of the FIGS. 7A-7C includes the wireless Internet of things (IoT) device 28 of FIG. 1 and/or the wireless medical device 26 of FIG. 1, the facility device 32 of FIG. 1, the control server 20 of FIG. 1 and/or the external records server 22 of FIG. 1, and the user device 30 of FIG. 1 and/or the computing device 36 of FIG. 1. A regulatory region may include regulatory compliance requirements associated with medical devices and/or statutory acts surrounding privacy of medical data. For example, the United States Food and Drug Administration (FDA) regulates medical devices and information systems associated with medical devices. As another example, the health insurance portability and accountability act (HIPAA) establishes procedures of individual health information privacy rights.

FIG. 7A illustrates an example that is free of a regulatory region as the data messages 48 and information messages 50 pertain to IoT device data (e.g., non-medical). In an example of operation, the wireless IoT device 28 obtains the IoT device data, determines (e.g., mapping an artifact of the wireless IoT device 28 to a regulatory region list of configuration information) that a regulatory region does not apply to the IoT device data, encodes the IoT device data to produce the data messages 48 without regard to regulatory compliance, and sends the data message 48 to the facility device 32. Having received the data message 48, the facility device 32 determines that a regulatory region does not apply to the data message 48, determines a processing approach for the data message 48 without regard to regulatory compliance, and sends the data message 48 to the control server 20. Having received the data messages 48, the control server 20 determines that a regulatory region does not apply to the data message 48, determines a processing approach for the data message 48 without regard to regulatory compliance, processes the data message 48 to produce an information message 50 (e.g., interprets the IoT device data to produce a summary for the information message 50), and sends the information message 50 to the user device 30.

FIG. 7B illustrates an example that is subject to a regulatory region as the data messages 48 and information messages 50 pertain to medical device data. In an example of operation, the wireless medical device 26 obtains the medical device data, determines (e.g., predetermined mapping of an artifact of the wireless medical device 26 to a regulatory region list of configuration information) that a first regulatory region 120 (e.g., FDA medical device) applies to the wireless medical device 26, transforms the medical device data from a first format to a second format with compliance to the first regulatory region 120 to produce a data message 48, and sends the data message 48 to the facility device 32.

Having received the data message 48, the facility device 32 determines that the first regulatory region 120 (e.g., FDA-medical data device system) applies to the data message 48 based on configuration information 116 received from the control server 20, determines a processing approach for the data message 48 compliant with the first regulatory region 120 (e.g., based on the configuration information 116), transforms the data messages 48 from the second format to a third format to produce another data message 48, and sends the other data message 48 to the control server 20.

Having received the other data messages 48, the control server 20 determines that a second regulatory region 122 (e.g., HIPAA) applies to the data message 48, determines a processing approach for the data message 48 compliant with the second regulatory region 122, processes the data message 48 to produce an information message 50 (e.g., produces display data with a privacy aspect) and sends the information message 50 to the user device 30 for display.

FIG. 7C illustrates an example that is subject to a regulatory region as the data messages 48 and an information messages 124 pertain to medical device data. In an example of operation, the wireless medical device 26 obtains the medical device data, determines (e.g., predetermined mapping of an artifact of the wireless medical device 26 to a regulatory region list of configuration information) that the first regulatory region 120 (e.g., FDA medical device) applies to the wireless medical device 26, transforms the medical device data from a first format to a second format with compliance to the first regulatory region 120 to produce the data message 48, and sends the data message 48 to the facility device 32.

Having received the data message 48, the facility device 32 determines that the first regulatory region 120 (e.g., FDA-medical data device system) applies to the data message 48 based on configuration information, determines a processing approach for the data message 48 compliant with the first regulatory region 120, transforms the data messages 48 from the second format to the third format compatible with the external records server 22 to produce another data message 48, and sends the other data message 48 to the external record server 22.

Having received the other data messages 48, the control server 20 determines that a second regulatory region 122 (e.g., HIPAA) applies to the data message 48, determines a processing approach for the data message 48 compliant with the second regulatory region 122, processes the data message 48 to produce an information message 124 (e.g., provides a security aspect for enhanced privacy) and sends the information message 124 to the computing device 36 for display and/or storage in accordance with the security aspect for enhanced privacy.

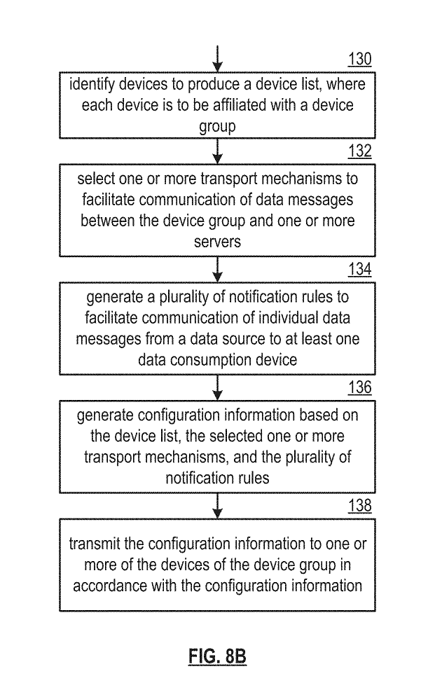

FIG. 8A is a schematic block diagram of another embodiment of a medical device data system (MDDS) that includes a plurality of device groups A-Z, the network 24 of FIG. 1, and the control server 20 of FIG. 1. Each device group includes a corresponding sensor group, a facility device, a plurality of user devices, and a plurality of computing devices. Each sensor group includes a plurality of wireless medical devices and/or a plurality of wireless Internet of things (IoT) devices. Each wireless medical device 1-M may be implemented utilizing the wireless medical device 26 of FIG. 1. Each wireless IoT device 1-N may be implemented utilizing the wireless IoT device 28 of FIG. 1. Each facility device A-Z may be implemented utilizing the facility device 32 of FIG. 1. Each user device 1-U may be implemented utilizing the user device 30 of FIG. 1. Each computing device 1-C may be implemented utilizing the computing device 36 of FIG. 1. The control server 20 includes the processing module 38 of FIG. 1 and the database 40 of FIG. 1. The MDDS functions to establish configuration information.

In an example of operation of the establishing of the configuration information, the processing module 38 identifies identifiers of devices within each device group. The identifying includes one or more of interpreting a query response, interpreting an affiliation message, initiating a device scan, and interpreting a scan result, where the sensor group pairs with a facility device, and the facility device pairs with user devices and/or computing devices to perform the device group.

Having identified the devices of the device group, the processing module 38 specifies transport mechanisms including selection of primary backhaul for data messages between the device group and the control server 20. The specifying includes one or more of interpreting a test result, interpreting system registry information, interpreting characteristics of each device, identifying one or more servers (e.g., the control server, an extra record server, etc.), determining a performance level of a communication path, determining a required performance level for the communication path, comparing the performance level of the communication path to the required performance over for the communication path, identifying a favorable communication path, and listing communication path attributes and/or identifiers (e.g., wireline type, wireless type, port numbers, IP addresses, security methods, transport formats, software drivers).

Having specified the transport mechanisms, the processing module 38 establishes notification rules that includes one or more of peripheral threshold values, metadata types, notification methods (e.g., text, email, data transfer, website access), events for notification, timeouts for notification, and reminder schedules. The establishing includes one or more of interpreting a user input, interpreting the registry information, interpreting a default rule, and identifying requirements of a data consumption device (e.g., of a user device 30 and/or of a computing device 36).

Having established the notification rules, the processing module 38 generates configuration information based on the device list, the selected one or more transport mechanisms, and the plurality of notification rules. For example, the processing module 38 aggregates the device list, the selected one or more transport mechanisms, and the plurality of notification rules to produce a configuration file.

Having generated the configuration information, the processing module 38 facilitates pushing the configuration information to the device group in accordance with the configuration information. For example, the processing module 38 sends the configuration file to devices specified by the configuration information (e.g., to a facility device but not to a medical sensor since it is preprogrammed in accordance with regulatory requirements) and stores the configuration file in the database 40.

FIG. 8B is a logic diagram of an embodiment of a method for establishing configuration information. The method includes step 130 where a processing module (e.g., of a control server) identifies devices to produce a device list, where each device is to be affiliated with a device group. The identifying may be based on one or more of a predetermination, system registry information, auto-discovery, scanning, selecting, and pairing. The identifying may further include generating a device list to include one or more identifiers and associated characteristics (e.g., operational information, configure shoe requirements, model number, serial number, sufferer version number, etc.) of the identified devices.

The method continues at step 132 where the processing module selects one or more transport mechanisms to facilitate communication of data messages between the device group and one or more servers. The selecting includes one or more of identifying the one or more servers (e.g., a control server, and external records server), identifying candidate communication paths, interpreting a test result, interpreting the system registry information, interpreting the characteristics of each device, and selecting at least one favorable communication path.

The method continues at step 134 where the processing module generates a plurality of notification rules to facilitate communication of individual data messages from a data source (e.g., a wireless medical device) to at least one data consumption device (e.g., a computing device). The generating includes one or more of interpreting a user input, interpreting the system registry information, interpreting a default rule, and identifying requirements of the at least one data consumption device. The notification rules include one or more of a data type, data threshold levels, notification methods, event types, notification timeouts (e.g., he time frame without announcement of a notification), reminder schedules, notification schedules, escalation instructions, and data manipulation restrictions (e.g., interpretation of data to produce information).

The method continues at step 136 where the processing module generates configuration information based on the device list, the selected one or more transport mechanisms, and the plurality of notification rules. For example, the processing module aggregates the device list, the selected one or more transport mechanisms, and the plurality of notification rules to produce a configuration file. The method continues at step 138 where the processing module transmits the configuration information to one or more of the devices of the device group in accordance with the configuration information. For example, the processing module identifies recipients of the configuration information (e.g., predetermined, in accordance with the configuration information, in accordance with a user input) and sends the configuration file to the identified recipients.

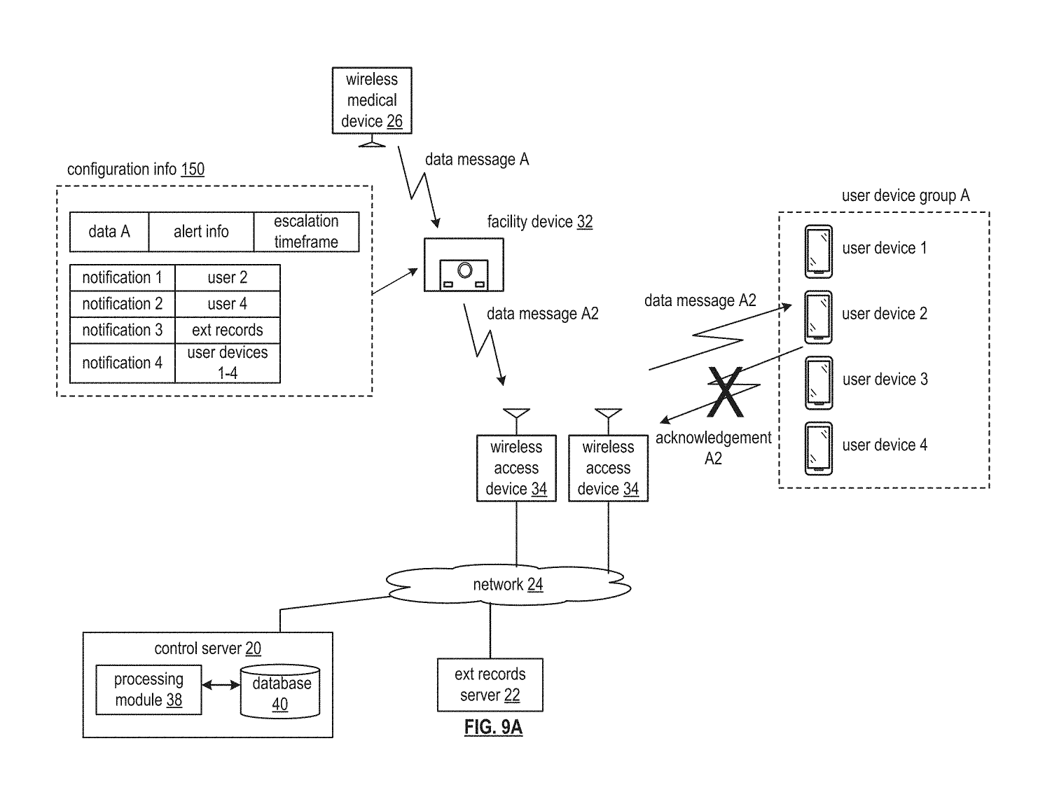

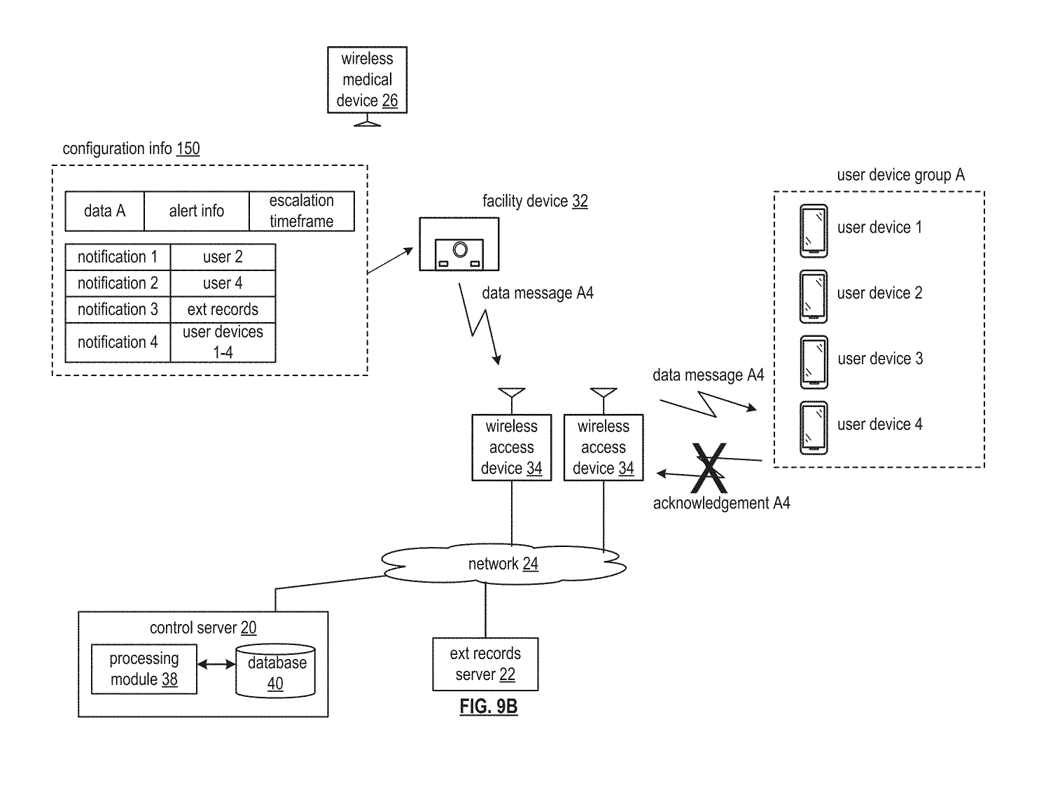

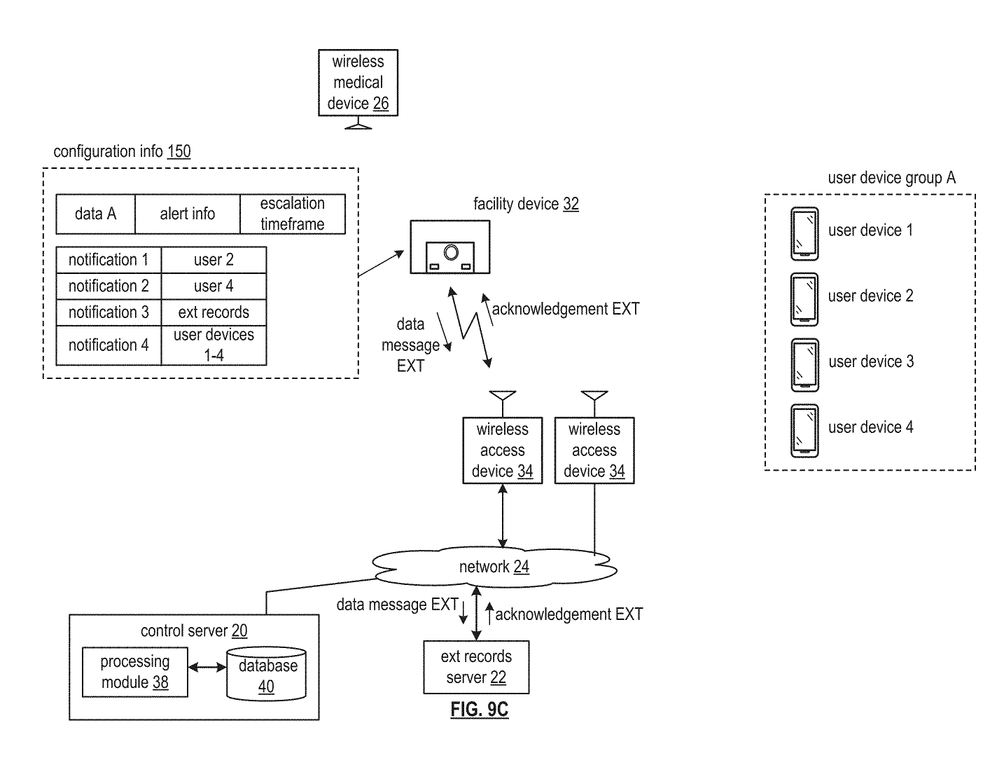

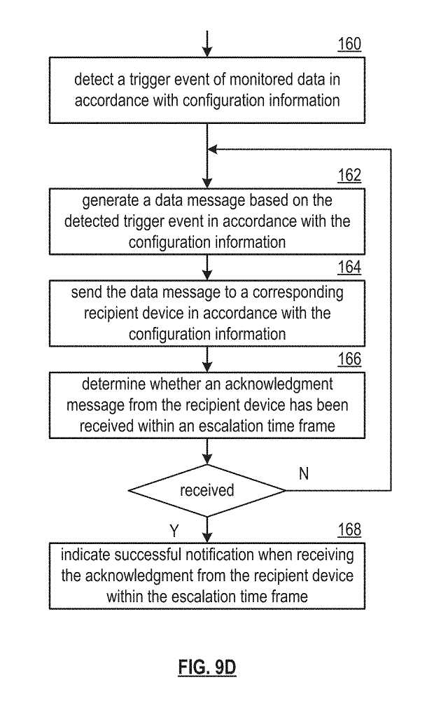

FIGS. 9A, 9B, and 9C are schematic block diagrams of another embodiment of a medical device data system (MDDS) that includes the wireless medical device 26 of FIG. 1, the facility device 32 of FIG. 1, a plurality of wireless access devices 34 of FIG. 1, the network 24 of FIG. 1, the control server 20 of FIG. 1, the external records server 22 of FIG. 1, and a user device group A. The user device group A includes a plurality of user devices 1-4. The user device group A may further include one or more of the computing devices 36 of FIG. 1. The control server 20 includes the processing module 38 of FIG. 1 and the database 40 of FIG. 1. The MDDS functions to escalate an alert in accordance with configuration information 150, where the configuration information 150 includes one or more of a data indicator (e.g., what type of data), alert information (e.g., what triggers an event), an escalation time frame (e.g., timeframe between detecting a failed notification of an alert and sending of the alert to a next recipient), a notification (e.g., format, content), and an identifier of a recipient of the alert (e.g., which user device, extra record server, or other).

FIG. 9A illustrates an example of operation of the escalating of the alert, where the facility device 32 detects a trigger event of monitored data in accordance with configuration information 150. The detecting includes comparing the monitored data to a data threshold level and/or data pattern associated with the trigger event (e.g., of the alert information) and indicating the trigger event when the data compares favorably to the data threshold level and/or to the data pattern. For example, the facility device 32 receives a data message A from the wireless medical device 26 and identifies a condition for triggering the alert (e.g., in accordance with the alert information).

Having detected the trigger event, the facility device 32 generates a first data message based on the detected trigger event in accordance with the configuration information. For example, the facility device 32 generates a data message A2 indicating the trigger event, which may include a portion of the data message A in accordance with the notification 1 of the configuration information 150. Having generated the first data message, the facility device 32 sends the first data message to a corresponding recipient device in accordance with the configuration information. For example, the facility device 32 sends, via the plurality of wireless access devices 34 and the network 24, the first data message A2 to the user device 2.

Having sent the first data message, the facility device 32 determines whether the first data message has been successfully delivered to the corresponding recipient. For example, the facility device 32 determines whether an acknowledgment A2 has been received within the escalation time frame of the configuration information 150. For instance, the facility device 32 indicates that the first data message has not been successfully delivered to the corresponding recipient within the escalation time frame when not receiving the acknowledgment A2 from the user device 2 within the escalation time frame.

FIG. 9B further illustrates the example of operation of the escalating of the alert, where, when the facility device 32 determines that the first data message has not been received by the corresponding recipient, the facility device 32 identifies a next recipient of a representation of the first data message. For example, the facility device 32 interprets the configuration 150 to identify user device 4 to be associated with a second notification (e.g., the next recipient of the representation of the first data message).

Having identified the next recipient, the facility device 32 generates a second data message based on the detected trigger event in accordance with the configuration information. For example, the facility device 32 generates a data message A4 indicating the trigger event, which may include a portion of the data message A in accordance with the configuration information 150 (e.g., of the notification 2). Having generated the second data message, the facility device 32 sends the second data message to the next recipient in accordance with the configuration information. For example, the facility device 32 sends, via the plurality of wireless access devices 34 and the network 24, the data message A4 to the user device 4.

Having sent the second data message, the facility device 32 determines whether the second data message has been successfully delivered to the next recipient. For example, the facility device 32 determines whether an acknowledgment A4 has been received within the escalation time frame of the configuration information 150. For instance, the facility device 32 indicates that the second data message has not been successfully delivered to the next recipient within the escalation time frame when not receiving the acknowledgment A4 from the user device 4 within the escalation time frame.

FIG. 9C further illustrates the example of operation of the escalating of the alert, where, when the facility device 32 determines that the second data message has not been received by the next recipient, the facility device 32 identifies a further recipient of a representation of the first data message. For example, the facility device 32 interprets the configuration 150 to identify the external records server 22 be associated with a third notification (e.g., another next recipient of the representation of the first data message).

Having identified the further recipient, the facility device 32 generates a third data message based on the detected trigger event in accordance with the configuration information. For example, the facility device 32 generates a data message EXT indicating the trigger event, which may include a portion of the data message A in accordance with the configuration information 150 (e.g., of the notification 3). Having generated the third data message, the facility device 32 sends the third data message to the further recipient in accordance with the configuration information. For example, the facility device 32 sends, via the wireless access device 34 and the network 24, the data message EXT to the external records server 22.

Having sent the second data message, the facility device 32 determines whether the third data message has been successfully delivered to the further recipient. For example, the facility device 32 determines whether an acknowledgment EXT has been received within the escalation time frame of the configuration information 150. For instance, the facility device 32 indicates that the third data message has been successfully delivered to the further recipient within the escalation time frame when receiving the acknowledgment EXT from the external records server 22 within the escalation time frame.

FIG. 9D is a logic diagram of an embodiment of a method for escalating an alert. The method includes step 160 where a processing module (e.g., of a facility device) detects a trigger event of monitored data in accordance with configuration information. The detecting includes one or more of comparing the monitor data to a threshold level/pattern and indicating the trigger event when the comparison is favorable (e.g., substantially the same).

The method continues at step 162 where the processing module generates a data message based on the detected trigger event in accordance with the configuration information. The generating includes one or more of including a trigger identifier, including a portion of the monitor data, including a portion of historically monitored data (e.g., similar data monitored and a previous time frame), including an identifier of a data source of the monitor data, including an escalation time frame, and including a list of recipient devices in accordance with the configuration information.

The method continues at step 164 where the processing module sends the data message to a corresponding recipient device in accordance with the configuration information. The sending includes identifying a recipient device from the configuration information based on a previous recipient device if any. The method continues at step 166 for the processing module determines whether an acknowledgment message from the recipient device has been received within an escalation time frame. The determining includes extracting the escalation time frame from the configuration information, comparing time since sending the data message to the escalation time frame, and indicating not received when the comparison is favorable and the announcement has not yet been received. The method loops back to step 162 when the processing module determines that the acknowledgment has not been received from the recipient device within the escalation time frame. The method continues to step 168 when the processing module determines that the announcement has been received from the recipient device within the escalation time frame.

When the acknowledgment has been received from the recipient device within the escalation time frame, the method continues at step 168 where the processing module indicates successful notification when receiving the announcement from the recipient device within the escalation time frame. The indicating includes one or more of suspending further notifications, facilitating updating of a historical record, and sending a notification of successful alerting to one or more recipient devices in accordance with the configuration information (e.g., to all members of a user device group). Alternatively, the corresponding recipient device may include a plurality of recipient devices and the determining whether the acknowledgment message has been received from the recipient device includes determining whether an announcement message from each recipient device has been received within escalation time frame.

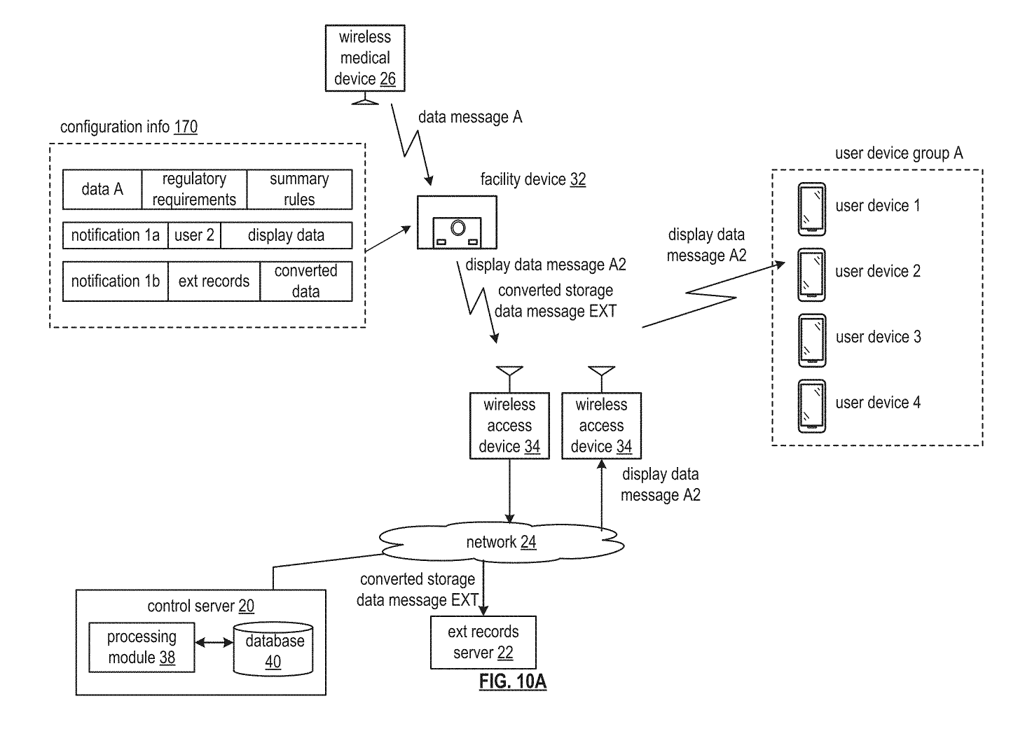

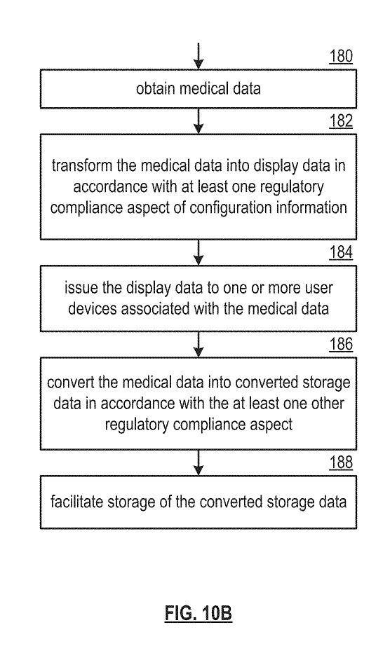

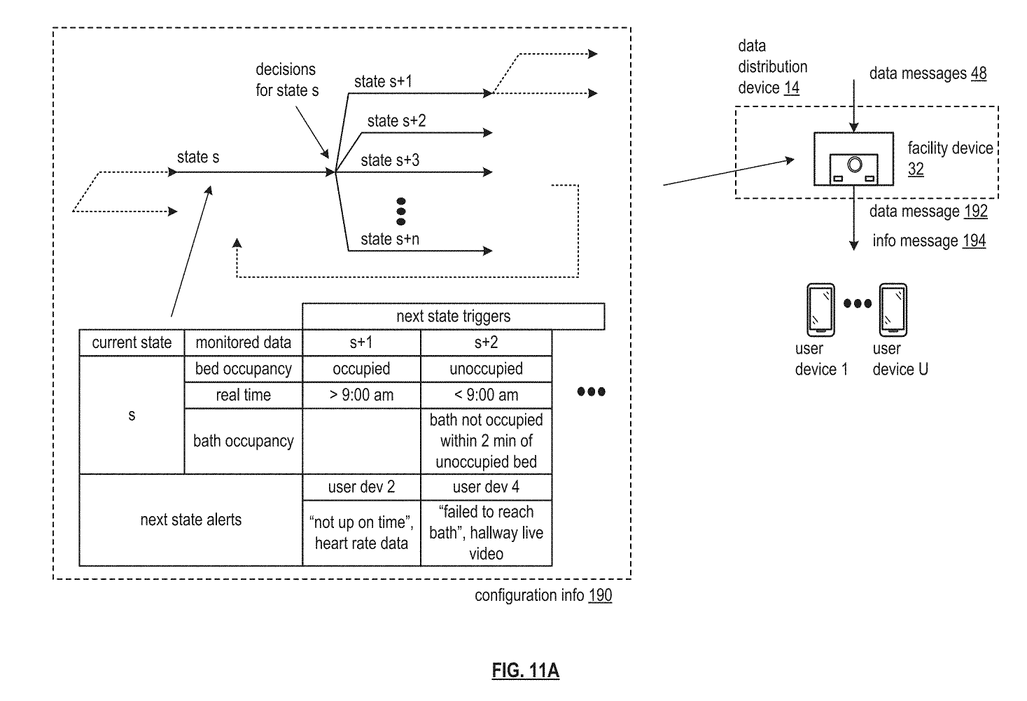

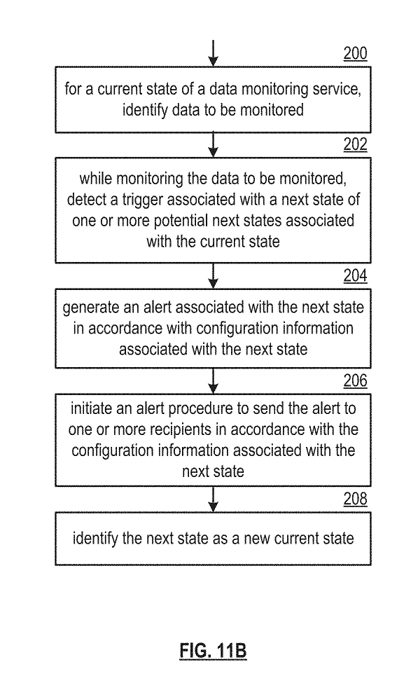

FIG. 10A is a schematic block diagram of another embodiment of a medical device data system (MDDS) that includes the wireless medical device 26 of FIG. 1, the facility device 32 of FIG. 1, a plurality of wireless access devices 34 of FIG. 1, the network 24 of FIG. 1, the control server 20 of FIG. 1, the external records server 22 of FIG. 1, and a user device group A. The user device group A includes a plurality of user devices 1-4. The user device group A may further include one or more of the computing devices 36 of FIG. 1. The control server 20 includes the processing module 38 of FIG. 1 and the database 40 of FIG. 1. The MDDS functions to distribute data in accordance with configuration information 170, where the configuration information 170 includes one or more of a data indicator (e.g., what type of data), regulatory requirements (e.g., handling of data, storing of data, displaying of data, etc.), summary rules (e.g., allowable interpretations of monitored data), notifications, including recipients and notification message content (e.g., how to display data, how to convert data, etc. in accordance with the regulatory requirements).

In an example of operation of the distributing of the data, the facility device 32 obtains medical data. For example, the facility device 32 receives a data message A from the wireless medical device and temporarily stores the obtained medical data, where the wireless medical device 26 encodes the data message A to include medical device data as the medical data. As another example, the facility device 32 retrieves temporarily stored medical data to produce the medical data.

Having obtained the medical data, the facility device 32 transforms the medical data into display data in accordance with the configuration information 170 for the medical data. For example, the facility device 32 interprets the configuration information 170 to identify a display data approach (e.g., a specified display format of a plurality of display formats) for a notification la to the user device 2 and converts the data message A into a display data message A2 utilizing the display data approach.

Having transformed the medical data into the display data, the facility device 32 sends the display data to one or more of the user devices in accordance with the configuration information. For example, the facility device 32 identifies the user device 2 to receive the notification la and sends, via the plurality of wireless access devices 34 and the network 24, the display data message A2 to the user device 2.

Having sent the display data, the facility device 32 further interprets the configuration information 170 to identify another task associated with a notification 1b, where converted medical data is to be sent to the external records server 22. For example, the facility device 32 interprets the notification 1b of the configuration information 170 to identify a conversion approach (e.g., convert from a first format into a records format in compliance with the regulatory requirements, data block formats, file formats, time sorts, etc.) and converts the medical data of the data message A utilizing the conversion approach to produce a converted storage data message EXT. Having converted the medical data into the converted storage data, the facility device 32 sends the converted storage data to the external records server 22. For example, the facility device 32 sends, via the wireless access device 34 and the network 24, the converted storage data message EXT to the external records server 22.

FIG. 10B is a logic diagram of an embodiment of a method for distributing data. The method includes step 180 where a processing module (e.g., of a facility device) obtains medical data. The obtaining includes one or more of receiving the medical data from one or more medical devices, receiving the medical data from a facility device, temporarily storing the medical data, and retrieving the temporarily stored medical data.

The method continues at step 182 where the processing module transforms the medical data into display data in accordance with at least one regulatory compliance aspect of configuration information. The transforming includes one or more of interpreting the configuration information based on the medical data to identify transformation aspects and processing the medical data in accordance with the transformation aspects to produce the display data.

The method continues at step 184 where the processing module issues the display data to one or more user devices associated with the medical device, where at least one of the user devices displays the display data. The issuing includes one or more of identifying the one or more user devices based on one or more of the configuration information, a query response, and a request, and sending the display data to the one or more identified user devices.

The method continues at step 186 where the processing module converts the medical data into converted storage data in accordance with at least one other regulatory compliance aspect. The converting includes interpreting the configuration information to produce the at least one regulatory compliance aspect and converting the medical data in accordance with the at least one regulatory compliance aspect to produce the converted storage data.

The method continues at step 188 where the processing module facilitates storage of the converted storage data. For example, the processing module identifies one or more records servers based on the configuration information and sends the converted storage data to the one or more identified records servers for storage therein.

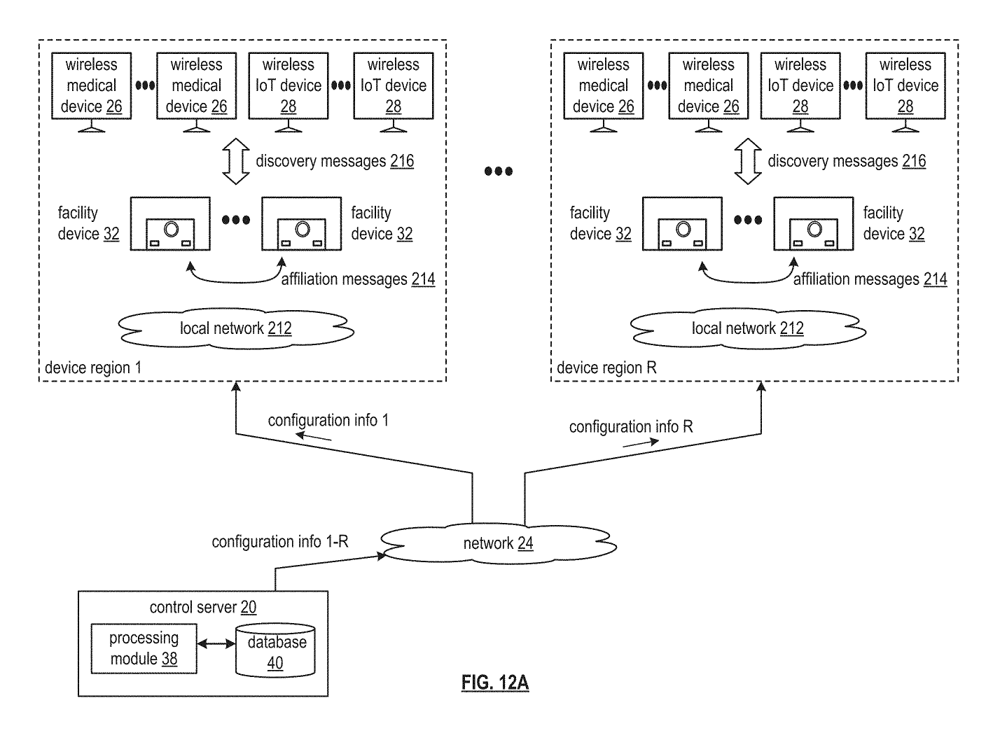

FIG. 11A is a schematic block diagram of another embodiment of a medical device data system (MDDS) that includes the data distribution device 14 of FIG. 1 and a plurality of user devices 1-U. The data distribution device 14 includes the facility device 32 of FIG. 1. Alternatively, the data distribution device 14 may include the user device 30 of FIG. 1. The facility device 32 functions to detect a state trigger in accordance with configuration information 190. The configuration information 190 includes one or more of a current state identifier, monitored data associated with the current state (e.g., via data messages 48 from external sensors, via a sensor and/or user input internal to the facility device 32), and next state trigger information. The next state trigger information includes one or more identifiers of one or more possible next states from the current state, for each monitor data, a data value and/or pattern associated with a trigger, and for each next state, next state alerts (e.g., data messages 192, information messages 194). Each next state alert includes an identifier of one or more recipients and data and/or a message for including in an alert to be sent to the one or more recipients.

In an example of operation of the detecting of the state trigger, the facility device 32, for a current state, identifies data to be monitored. The identifying includes one or more of obtaining the configuration information 190 associated with the current state and extracting an identity of each type of data to be monitored. For example, for state s, the facility device 32 identifies data to be monitored to include bed occupancy (e.g., occupied, not occupied), real-time (e.g., time of day, date), and bath occupancy (e.g., occupied, not occupied).

While monitoring the data to be monitored, the facility device 32 detects a trigger associated with a next state of one or more potential next states associated with the current state. The detecting includes one or more of comparing one or more monitor data values to one or more associated threshold values in accordance with the configuration information 190 and indicating detection of the trigger when a comparison is favorable. For example, the facility device 32 detects that a bed is occupied after 9 AM and indicates detection of trigger for state s+1. As another example, the facility device 32 detects that the bed is not occupied before 9 AM and a bath is not occupied within two minutes of the unoccupied bed and indicates detection of trigger for state s+2.

Having detected the trigger associated with the next state, the facility device 32 generates an alert associated with the next state in accordance with the configuration information associated with the next date. The generating includes one or more of extracting alert generation information from the configuration information (i.e., a message, a data pass-through, a data interpretation requirement, a data display requirement, etc.) and generating the alert from one or more of a message and a representation of at least one monitor data in accordance with the alert generation information. For example, the facility device 32, when detecting next state s+1, extracts a message “not up on time” and a requirement to obtain heart rate data from the configuration information 190, obtains data messages 48 that includes the heart rate data, and generates one or more of a data message 192 and an information message 194 as the alert that includes the message and the heart rate data. As another example, the facility device 32, when detecting next state s+2, extracts a message “failed to reach bath” and a requirement to obtain hallway live video from the configuration information 190, obtains another data message 48 that includes the hallway live video, and generates one or more of the data message 192 and the information message 194 as the alert to include the message and the hallway live video (e.g., a stream, a timed video segment).

Having generated the alert, the facility device 32 initiates alert procedure to send the alert to one or more recipients in accordance with the configuration information 190 associated with the next state. The initiating includes identifying the one or more recipients from the configuration information 190, sending the alert to at least one of the identified one or more recipients in accordance with an escalation procedure of the configuration information 190, and when escalation is required, sending a representation of the alert to at least one other recipient. For example, the facility device 32 identifies user device 2 as the recipient for the alert associated with the next state s+1 and sends the one or more of the data message 192 and the information message 194 associated with the next state s+1 to the user device 2. As another example, the facility device 32 identifies user device 4 as the recipient for the alert associated with the next state s+2 and sends the one or more of the data message 192 and the information message 194 associated with the next state s+2 to the user device 4.

Having successfully sent the alert to the one or more recipients, the facility device 32 identifies the next state associated with the trigger as a new current state. For example, the facility device 32 completes moving to the next date and utilizes further configuration information 190 as described above.

FIG. 11B is a logic diagram of an embodiment of a method for detecting a state trigger. The method includes step 200 where a processing module (e.g., of a data distribution device), for a current state of a data monitoring service, identifies data to be monitored. The identifying includes one or more of obtaining configuration information associated with the current state, extracting an identity of one or more datatypes to be monitored, and identifying one or more data sources associated with the datatypes.

While monitoring the data to be monitored, the method continues at step 202 where the processing module detects a trigger associated with a next state of one or more potential next states associated with the current state. The detecting includes one or more of comparing one or more monitor data values to one or more associated threshold values and/or data patterns in accordance with the configuration information and indicating detection of a trigger when a comparison is favorable.

The method continues at step 204 where the processing module generates an alert associated with the next state in accordance with configuration information associated with the next state. The generating includes one or more of extracting alert generation information from the configuration information and generating the alert from one or more of a message and a representation of at least one monitor data in accordance with the alert generation information.

The method continues at step 206 where the processing module initiates an alert procedure to send the alert to one or more recipients in accordance with the configuration information associated with the next state. The initiating includes one or more of identifying the one or more recipients from the configuration information sending the alert to at least one of the identified one or more recipients in accordance with an escalation procedure of the configuration information, and when escalation is required, sending a representation of the alert to at least one other recipient. The method continues at step 208 where the processing module identifies the next state as a new current state. The method may loop back to step 200.

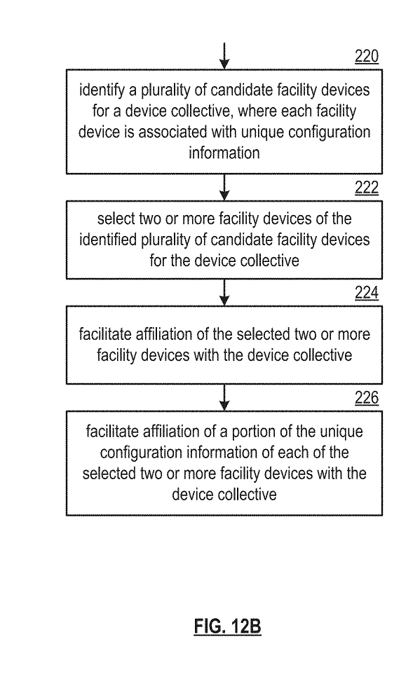

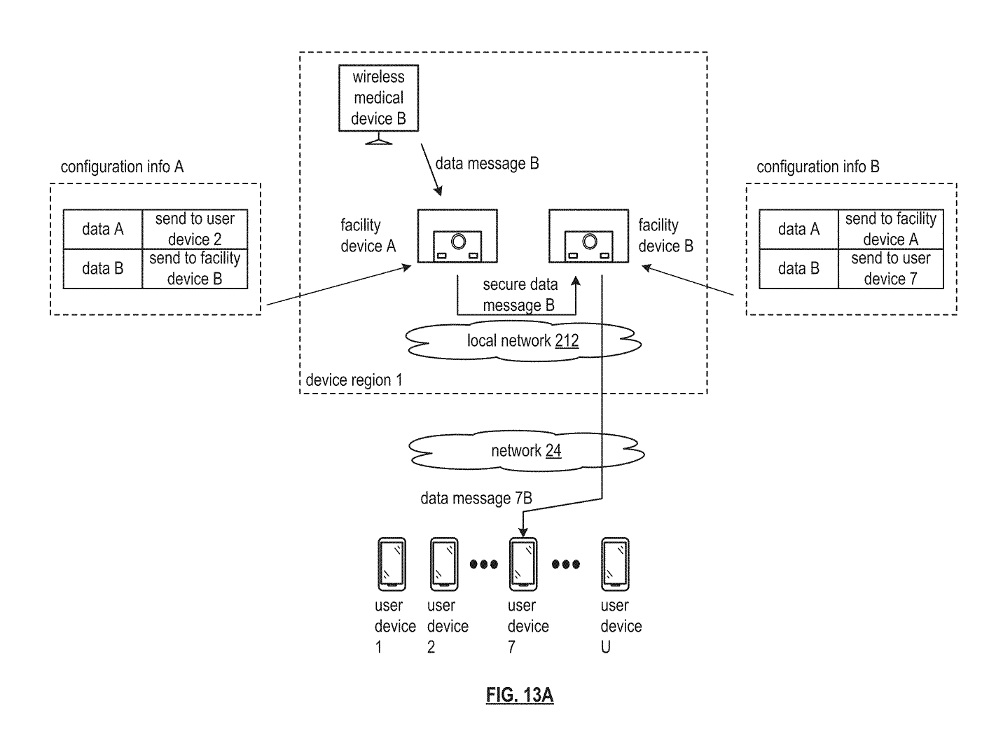

FIG. 12A is a schematic block diagram of another embodiment of a medical device data system (MDDS) that includes a plurality of device regions 1-R, the network 24 of FIG. 1, and the control server 20 of FIG. 1. Each device region includes one or more wireless medical devices 26 of FIG. 1 and one or more wireless Internet of things (IoT) devices 28 of FIG. 1, a plurality of facility devices 32 of FIG. 1, and a local network 212. The local network 212 may be implemented utilizing one or more of a wireline Internet protocol network (e.g., a routed IP network) and a wireless Internet protocol network (e.g., Wi-Fi, Bluetooth, etc.). The control server 20 includes the processing module 38 of FIG. 1 and the database 40 of FIG. 1. The MDDS functions to affiliate a plurality of facility devices.

In an example of operation of the affiliation of the plurality of facility devices, a facility device 32 of region 1 identifies a plurality of candidate facility devices 32 for a device collective, where each facility device 32 is associated with unique configuration information and where the control server 20 issues, via the network 24, configuration information (e.g., configuration info 1-R) to the facility devices 32. The identifying includes one or more of extracting predetermined device identifiers from configuration information and pinging other devices via the local network 212. For example, the facility device 32 identifies each other facility device 32 associated with the device region 1 and one or more facility devices 32 associated with another data region.

Having identified the plurality of candidate facility devices, the facility device 32 selects two or more facility devices 32 of the identified plurality of candidate facility devices 32 for the device collective. The selecting includes identifying a commonality (e.g., within a common region/facility, belonging to a common user group, associated with a common purpose, etc.) and choosing facility devices associated with the identified commonality. For example, the facility device 32 of the device region 1 identifies device region 1 as the commonality when the facility device 32 is associated with the device region 1 and chooses facility devices 32 of the plurality of candidate facility devices 32 that are located within the device region 1 (e.g., comparing a location to a device region 1 boundary listed in configuration information).

Having selected two or more facility devices for the device collective, the facility device facilitates affiliation of the two or more facility devices with the device collective. The facilitating includes one or more of sending an affiliation request as an affiliation message 214 to the selected two or more facility devices, interpreting affiliation response messages, and establishing the affiliation (e.g., forming a new collective, joining an existing collective).

Having facilitated the affiliation of the two or more facility devices, the facility device facilitates affiliation of a portion of the unique configuration information of each of the selected two or more facility devices with the device collective. The facilitating includes sharing affiliation messages 214 between the facility devices 32 that includes the configuration information of each of the facility devices (e.g., security parameters, trust information, etc.), exchanging discovery messages 216 with one or more wireless medical devices 26 and wireless IoT devices 28 (e.g., within proximity), and associating at least one facility device 32 with the control server 20 (e.g., selecting a facility device associated with a high-performing connectivity path from the selected facility device to the control server 20 via the network 24).

FIG. 12B is a logic diagram of an embodiment of a method for affiliating a plurality of facility devices. The method includes step 220 where a processing module (e.g., of a facility device) identifies a plurality of candidate facility devices for a device collective, where each facility device is associated with unique configuration information. The identifying includes one or more of extracting predetermined device identifiers from configuration information, receiving an identification message, and pinging other facility devices via a local area network.

The method continues at step 222 where the processing module selects two or more facility devices of the identified plurality of candidate facility devices for the device collective. The selecting includes identifying a commonality and choosing facility devices associated with the identified commonality. For example, the processing module selects the commonality to include facility devices associated with a particular common facility and chooses facility devices affiliated with the common facility.

The method continues at step 224 where the processing module facilitates affiliation of the selected two or more facility devices with the device collective. The facilitating includes one or more of sending messages to request affiliation, interpreting affiliation response messages, and establishing the affiliation (e.g., forming a new collective, joining an existing collective).

The method continues at step 226 for the processing module facilitates affiliation of a portion of the unique configuration information of each of the selected two or more facility devices with the device collective. The facilitating includes one or more of sending affiliation messages that includes the configuration information, exchanging discovery messages with one or more wireless medical devices and wireless Internet of things devices, associating a facility device with one or more of the wireless medical and wireless Internet of things devices, and associating another facility device with a network connection to an external entity.

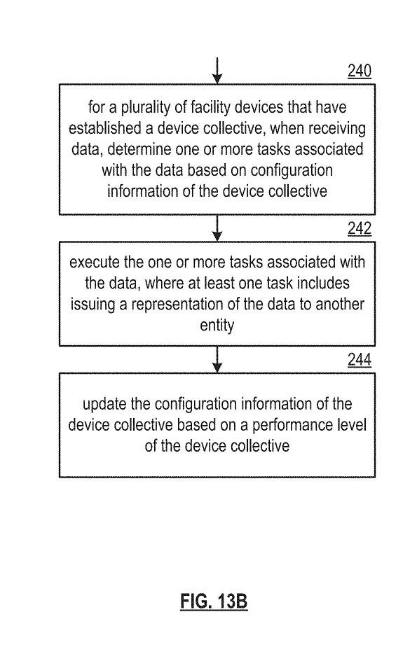

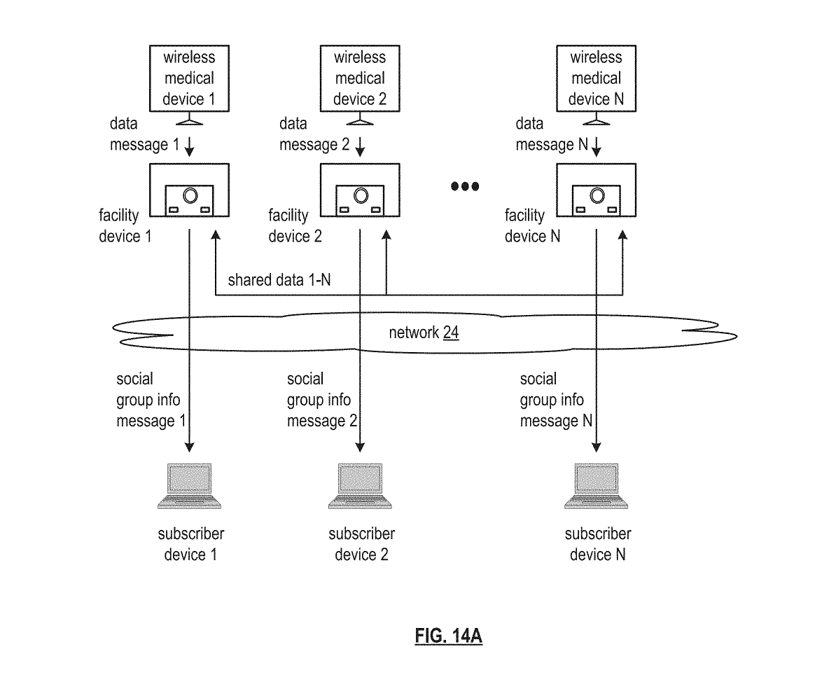

FIG. 13A is a schematic block diagram of another embodiment of a medical device data system (MDDS) that includes a device region 1, the network 24 of FIG. 1, and a plurality of user devices 1-U. The device region 1 includes a wireless medical device B, a plurality of facility devices A-B, and the local network 212 of FIG. 12A. The wireless medical device B may be implemented utilizing the wireless medical device 26 of FIG. 1. The facility devices A-B may be implemented utilizing the facility device 32 of FIG. 1. The MDDS functions to share data distribution tasks, where each facility device is associated with unique configuration information. As an example of unique configuration information, facility device A is associated with configuration information A and facility device B is associated with configuration information B.

In an example of operation of the sharing of the data distribution tasks, for the plurality of facility devices A-B, where the plurality of facility devices have established a device collective (e.g., via affiliation messages over the local network 212), when receiving a data message from a source device, a first facility device identifies a facility device associated with the received data message. The identifying includes extracting an identifier from the received data message and interpreting configuration information of the device collective. For example, the facility device A receives a data message B from the wireless medical device B and interprets configuration info A to determine that data message B is associated with the facility device B.

Having identified the facility device associated with the received data message, the first facility device determines one or more tasks associated with the data message based on the identified facility device. The determining includes one or more of interpreting the configuration information of the device collective and interpreting historical performance levels of the device collective. For example, the facility device A interprets the configuration info A to determine that the task associated with the data message B include securely sending the data message B to facility device B via the local network 212 in accordance with a data privacy regulatory requirement.

Having determined the one or more tasks, the first facility device executes the one or more tasks associated with the data missed. For example, the facility device A encrypts the data message B to produce a secure data message B in accordance with the configuration information A and/or configuration information B (e.g., utilizing a unique shared key between facility devices A and B) and sends, via the local network 212, the secure data message B to the facility device B. Alternatively the facility device A sends the secure data message B directly to the user device 7 when the configuration information A and/or configuration information B indicates that the facility device A is to function as a trusted proxy for the facility device B.

When receiving the securely sent received data message, the second facility device determines the one or more tasks associated with the data message in accordance with the configuration information. The determining includes interpreting the configuration information of the device collective and interpreting instructions received with the data message from the first facility device. For example, the facility device B interprets the configuration information B to determine that the data message B is to be sent to the user device 7. As another example, the facility device B determines that the secure data message B is to be transformed into a second secure data message B before transmitting to the user device 7 in accordance with further privacy regulatory requirements.

Having determined the one or more tasks, the second facility device executes one or more tasks. The executing includes identifying one or more recipients of the data, processing the data to produce a recipient data message, and sending the recipient data message to the identified one or more recipients in accordance with the configuration information. For example, the facility device B identifies the user device 7 as the recipient based on the configuration information B, generates a data message 7B to include the secure data message B and sends, via the network 24, the data message 7B to the user device 7.

FIG. 13B is a logic diagram of an embodiment of a method for sharing data distribution tasks. The method includes step 240, where a processing module (e.g., of a facility device), for a plurality of facility devices that have established a device collective, when receiving data, determines one or more tasks associated with the data based on configuration information of the device collective. The determining includes one or more of interpreting the configuration information of the dice collective and interpreting a task identifier within the data.

The method continues at step 242 where the processing module executes the one or more tasks associated with the data, where at least one task includes issuing a representation of the data to another entity. Task examples includes the processing module securely sending the received data message to another facility device (e.g., when not a proxy of the other facility device in accordance with the configuration information), processing the data to produce a recipient data message, and sending the recipient data message to an identified recipient.

The method continues at step 244 where the processing module updates the configuration information of the device collective based on a performance level of the device collective. The updating includes one or more of obtaining the performance level of the device collective, (e.g., a lookup, receive, interpret a query response, interpret a test result, receive an error message), identifying an update to the configuration based on an optimization approach (e.g., distribute tasks from heavily loaded facility devices to lightly loaded facility devices, move tasks to more trusted facility devices), and pushing the updated configuration information to the plurality of facility devices. For example, at least one of the facility devices updates the configuration information to include proxy operation or to exclude the proxy operation based on one or more of performance information, security information, an error message, a trust level change, etc.

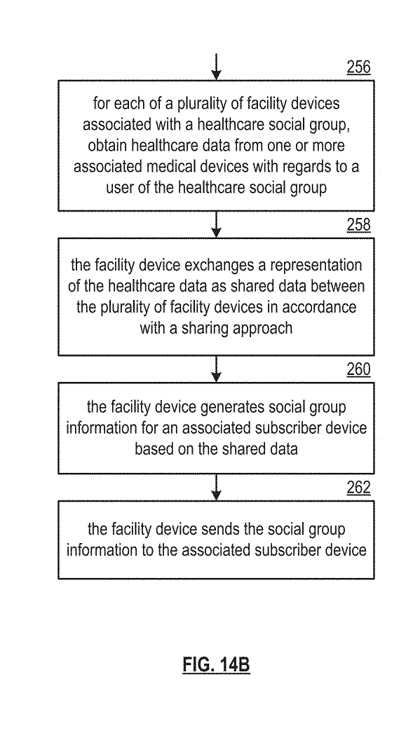

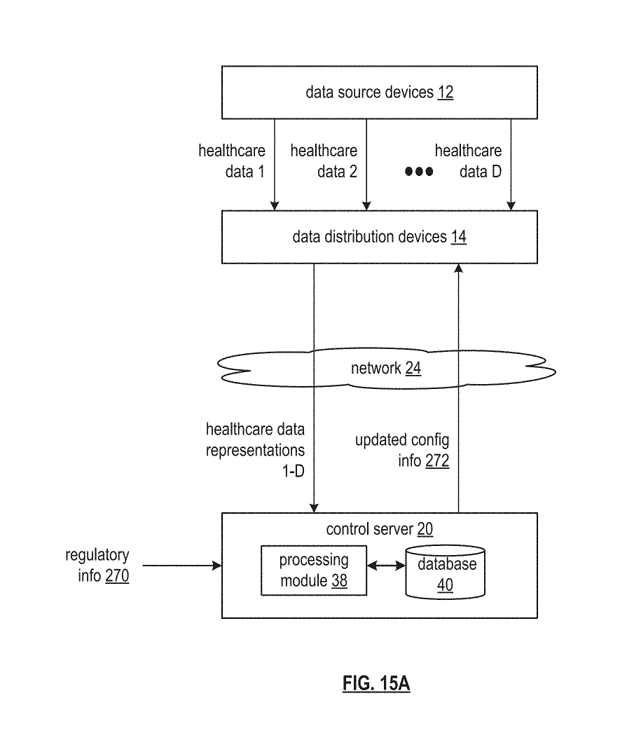

FIG. 14A is a schematic block diagram of another embodiment of a medical device data system (MDDS) that includes a plurality of wireless medical devices, referred to as wireless medical devices 1 through N, a plurality of facility devices, referred to as facility devices 1 through N, the network 24 of FIG. 1, and a plurality of subscriber devices, referred to as subscriber devices 1 through N. Each wireless medical device may be implemented utilizing the wireless medical device 26 of FIG. 1. Each facility device may be implemented utilizing the facility device 32 of FIG. 1. Each subscriber device may be implemented utilizing the subscriber device 36 of FIG. 1. The MDDS functions to share healthcare data.

In an example of operation of the sharing of the healthcare data, for each of the plurality of facility devices 1-N associated with a healthcare social group, any facility device obtains healthcare data from one or more associated medical devices 1-N with regards to a user of the healthcare social group. The obtaining includes one or more of receiving, interpreting a query response, and performing a lookup. For example, facility device 1 receives a data message 1 from the wireless medical device 1, where the data message 1 includes healthcare data 1 associated with a first user of the healthcare social group; facility device 2 receives a data message 2 from the wireless medical device 2, where the data message 2 includes healthcare data 2 associated with a second user of the healthcare social group; etc.

The facility device exchanges a representation of the healthcare data as share data between the plurality of facility devices in accordance with a sharing approach of the healthcare social group. The sharing approach includes one or more of sharing all healthcare data immediately, sharing when the data compares favorably to at least one of a data threshold level and/or a data pattern, sharing in accordance with a schedule, sharing when approved by an associated user, and sharing in response to a data query. The exchanging includes one or more of generating the representation of the data in accordance with the sharing approach, sending the representation of the data to at least some of the plurality of facility devices, and receiving data associated with the plurality of facility devices. For example, each of the facility devices 1-N transforms medical data 1-N in accordance with the configuration information to produce shared data 1-N and exchanges shared data 1-N with the plurality facility devices 1-N.

Having exchanged the healthcare data, the facility device generates social group information for an associated subscriber device based on the shared data. The generating includes one or more of producing display data, generating the comparison, excluding data that compares unfavorably to another data threshold and/or pattern, identifying data that compares favorably to other data, including data that is identified as desired comparative data, etc. For example, each facility device 1-N generates corresponding social group information messages 1-N, where each social group information message includes a side-by-side display of comparable medical data from the plurality of wireless medical devices 1-N. For instance, comparing heart rate information from a group of runners in a marathon. As another instance, comparing a number and a pace of steps for a 20-minute lunch break power walk amongst a group of coworkers. As yet another instance, comparing heart rates among the top twenty fastest weekend joggers across multiple cities.

Having generated the social group information, the facility device sends the social group information to the associate is discovered device. The sending includes identifying the associate is his favorite device and transmitting the social group information to the identified subset device. For example, facility device 1 identifies subscriber device 1 as associated with the facility device 1 and sends the social group information message 1, via the network 24, to the subscriber device 1 etc. Alternatively, or in addition to, one or more of the subscriber devices may individually or collectively update the sharing approach to include/exclude particular subscriber devices, to include/exclude particular healthcare data, and to include/exclude the generation of aspects of the social group information (e.g., which data, which comparisons, etc.).

FIG. 14B is a logic diagram of an embodiment of a method for sharing of healthcare data. The method includes step 256, where, for each of a plurality of facility devices associated with a healthcare social group, the facility device obtains healthcare data from one or more associated medical devices with regards to a user of the healthcare social group. The obtaining includes one or more of affiliating with the healthcare social group, receiving the healthcare data, interpreting a healthcare data query response, and performing a lookup of the healthcare data.

The method continues at step 258 where the facility device exchanges a representation of the healthcare data as share data between the plurality of facility devices in accordance with a sharing approach. The exchanging includes one or more of generating the representation of the data in accordance with the sharing approach, sending the representation of the data to at least some of the plurality of facility devices, and receiving data associated with the plurality of facility devices.

The method continues at step 260 where the facility device generates social group information for an associated subscriber device based on the shared data. The generating includes one or more of producing display data, generating a comparison, excluding data that compares unfavorably to a data threshold and/or pattern, including data that compares favorably to the data threshold and/or data pattern, including data identified in a social group request, including data associated with the social group, etc.

The method continues at step 262 where the facility device sends the social group information to the associated subscriber device. The sending includes one or more of directly sending the social group information to just the identified subscriber device (e.g., identifying the subscriber device and transmitting the social group information to the identified subset device) and posting the social group information on a shared social group information platform for access by one or more members of the social group.

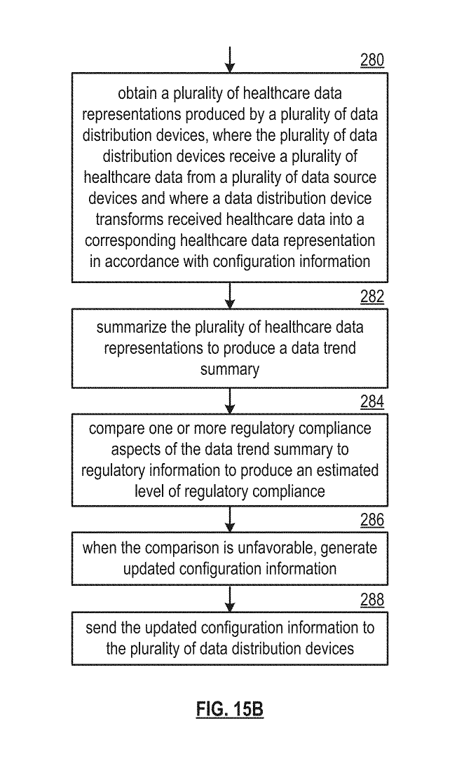

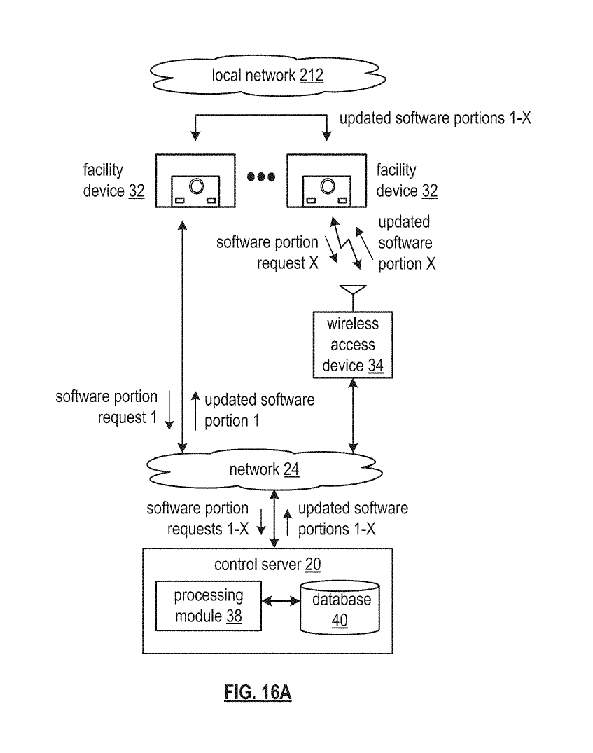

FIG. 15A is a schematic block diagram of another embodiment of a medical device data system (MDDS) that includes the data sources 12 of FIG. 1, the data distribution devices 14 of FIG. 1, the network 24 of FIG. 1, and the control server 20 of FIG. 1. The control server 20 includes the processing module 38 of FIG. 1 and the database 40 of FIG. 1. The MDDS functions to update configuration information associated with the MDDS based on regulatory information 270.

In an example of operation of the updating of the configuration information, the processing module 38 obtains, via the network 24, a plurality of healthcare data representations 1-D produced by the data distribution devices 14, where the data distribution devices 14 receives a plurality of healthcare data 1-D from the data source devices 12 and where data distribution devices 14 transforms received healthcare data into a corresponding healthcare data representation in accordance with the configuration information. The obtaining includes one or more of receiving the healthcare data representation, interpreting a query response, and issuing a scheduled query.

Having obtained the healthcare data representations 1-D, the processing module 38 summarizes the plurality of healthcare data representations 1-D to produce a data trend summary. The summarizing includes one or more of performing a trend analysis, comparing a particular healthcare data representation to historical healthcare data representations (e.g., as stored in the database 40), comparing the healthcare data representations to expected data, and identifying regulatory compliance indicators (e.g., based on one or more of data type, data values, identifiers of the data source devices, and current regulatory information of the configuration information).

Having summarized the healthcare data representations, the processing module 38 compares one or more regulatory compliance aspects of the data trend summary to regulatory information 270 to produce an estimated level of regulatory compliance. The comparing includes one or more of obtaining current regulatory information 270 (e.g., receive from a government server, interpret a query response, lookup), identifying the one or more regulatory compliance aspects from the data trend summary (e.g., comparing to metrics associated with regulatory compliance), and interpreting the identified one or more regulatory compliance aspects with regards to the regulatory information 270 to produce the estimated level of regulatory compliance. For example, the processing module 38 compares a healthcare data transformation method utilized by a data source device 12 to an allowable healthcare data transformation method specified by the regulatory information 270 and indicates unfavorable compliance as the estimated level of regulatory compliance when the comparison is unfavorable (e.g., the healthcare data transformation method utilized by the data source 12 has been excluded by the government regulatory body to produce the regulatory information 270).

When the comparison is unfavorable, the processing module 38 generates updated configuration information 272 for the data distribution devices 14. The generating includes one or more of updating one or more configuration parameters and updating a portion of software utilized by the data distribution devices 14 based on the current regulatory information 270. For example, the processing module 38 updates the configuration information to exclude the healthcare data transformation method utilized by the data source device 12 and to include an alternative allowable healthcare data transformation method in accordance with the regulatory information 270. As another example, the processing module 38 facilitates modification of software (e.g., generates a new requirement, facilitate auto coding utilizing the new requirement, issuing a new software request, and receiving the new software) utilized by the data distribution devices 14 such that an updated method of operation of the data distribution devices 14 is favorably in accordance with regulatory compliance of the regulatory information 270.

Having generated the updated configuration information 272, the processing module 38 sends, via the network 24, the updated configuration information 272 to the data distribution devices 14, where the data distribution devices 14 update one or more operational aspects (e.g., how to transform the received healthcare data into the healthcare data representation) utilizing the updated configuration information 270.

FIG. 15B is a logic diagram of an embodiment of a method for updating configuration information. The method includes step 280 where a processing module (e.g., of a control server) obtains a plurality of healthcare data representations produced by a plurality of data distribution devices, where the plurality of data distribution devices receive a plurality of healthcare data from a plurality of data source devices and where a data distribution device transforms received healthcare data into a corresponding healthcare data representation in accordance with configuration information. The obtaining includes one or more of issuing configuration information to the plurality of data distribution devices, receiving the healthcare data, identifying a schedule, issuing a query, and interpreting a query response to extract the healthcare data representation.

The method continues at step 282 where the processing module summarizes the plurality of healthcare data representations to produce a data trend summary. The summarizing includes one or more of performing a trend analysis, comparing to historical data, comparing to expected data, and identifying regulatory compliance indicators.

The method continues at step 284 where the processing module compares one or more regulatory compliance aspects of the data trend summary to regulatory information to produce an estimated level of revelatory compliance. The comparing includes one or more of obtaining current regulatory information, identifying the one or more regulatory compliance aspects from the data trend summary, and interpreting the identified one or more regulatory compliance aspects with regards to the regulatory information to produce the estimated level of regulatory compliance.

When the comparison is unfavorable, the method continues at step 286 for the processing module generates updated configuration information. The generating includes updating one or more configuration parameters and updating a portion of software utilized by the data distribution devices based on the current regulatory information. The method continues at step 288 where the processing module sends the updated configuration information to the plurality of data distribution devices. The sending includes identifying each of the plurality of data distribution devices and transmitting the updated configuration information to the identified data distribution devices, where the data distribution devices update one or more operational aspects (e.g., how to transform the healthcare data into a corresponding healthcare data representation) utilizing the updated configuration information.

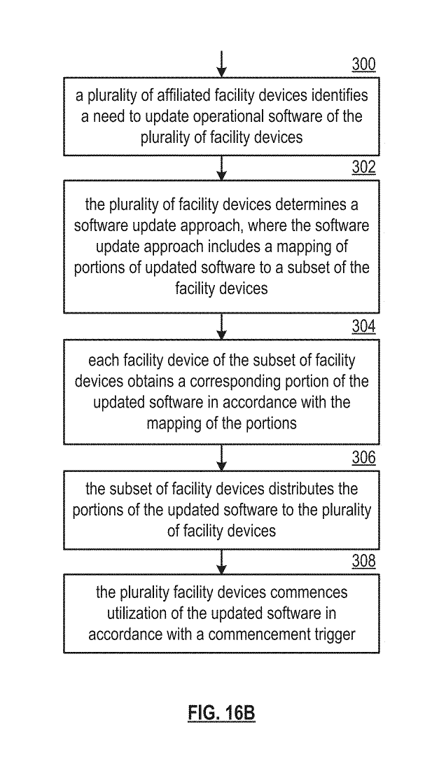

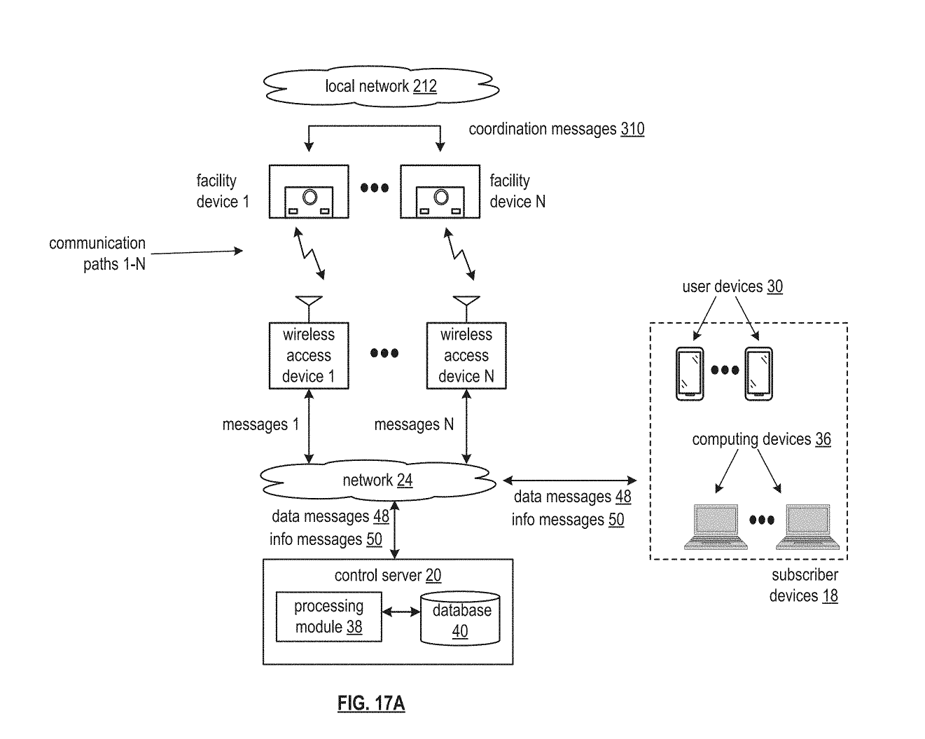

FIG. 16A is a schematic block diagram of another embodiment of a medical device data system (MDDS) that includes the local network to 12 of FIG. 12A, a plurality of affiliated facility devices 32 of FIG. 1, at least one wireless access device 34 of FIG. 1, the network 24 of FIG. 1, and the control server 20 of FIG. 1, where the facility devices 32 affiliate, via the local network 212, with each other to form a facility device collective. The control server 20 includes the processing module 38 of FIG. 1 and the database 40 of FIG. 1. The MDDS functions to update software for at least the facility devices 32.

In an example of updating the software, the plurality of affiliated facility devices 32 identifies a need to update operational software of the plurality of facility devices 32, where the plurality of affiliated facility devices 32 form the facility device collective and where a minimum level of trust is established to perform key operations including updating software. The identifying includes one or more of interpreting a schedule, interpreting an error message, receiving a notification, and identifying unfavorable handling of data with regards to a governmental regulatory compliance requirement.

Having identified the need to update the operational software, the plurality of facility devices 32 determines a software updating approach, where the software update in approach includes a mapping of portions of updated software to a subset of the facility devices. The determining includes one or more of interpreting connectivity performance levels between each facility device 32 and a source of the updated software (e.g., the control server 20), interpreting facility device availability levels, and assigning facility devices associated with favorable connectivity and performance to the portions of the updated software. For example, a first updated software portion is assigned to a first facility device, a second updated software portion is assigned to a second facility device, etc.

Having determined the software update approach, each of the subset of the facility devices 32 obtains a corresponding portion of the updated software in accordance with the mapping of the portions. The obtaining includes one or more of issuing a software portion request be a favorable connectivity path and receiving an updated software portion. For example, the first facility device 32 issues, via the network 24 a software portion request 1 to the control server 20, the processing module 38 divides the updated software to produce updated software portions 1-X, selects a portion of the updated software to produce the updated software portion 1, and sends, via the network 24, the updated software portion 1 to the first facility device 32, etc. Alternatively, or in addition to, the control server 20 may issue an updated software portion via the network 24 and the wireless access device 34 to a corresponding facility device 32.

Having obtained the corresponding portions of the updated software, the subset of facility devices distributes the portions of the updated software to the plurality of facility devices, where each facility device 32 aggregates a required number of portions to reproduce the updated software. The distributing includes one or more of interpreting a distribution plan (e.g., collecting, aggregating, sending a software aggregation, sending a portion) and exchanging, via the network 24, an aggregation and/or portion of the updated software portions 1-X to one or more other facility devices 32.

Having distributed the portions of the updated software, the plurality of facility devices 32 commences utilization of the updated software when detecting a commencement trigger. The detecting of the commencement trigger includes one or more of interpreting a commencement time frame, receiving an indication that substantially all of the plurality of facility devices are ready to utilize the updated software, receiving a command, and interpreting an error message.

FIG. 16B is a logic diagram of an embodiment of a method for updating software. The method includes step 300 where a plurality of affiliated facility devices identifies a need to update operational software of the plurality of facility devices, where the plurality of affiliated facility devices for me facility device collective and where a minimum level of trust established perform key operations including updating software. The identifying includes one or more of interpreting a schedule, receiving an error message, interpreting the received error message, and interpreting a software update notification.

The method continues at step 302 where the plurality of facility devices determines a software update approach, where the software update approach includes a mapping of portions of the updated software to a subset of the facility devices (e.g., from one to all of the facility devices). The determining includes interpreting connectivity performance levels between each facility device and a source of the updated software, interpreting facility device availability levels, and assigning facility devices associated with favorable connectivity and performance to the portions of the updated software.

The method continues at step 304 where each facility device of the subset of facility devices obtains a corresponding portion of the updated software in accordance with the mapping of the portions. The obtaining includes one or more of issuing a software portion request via a favorable connectivity path and receiving an updated software portion.

The method continues at step 306 where the subset of facility devices distributes the portions of the updated software to the plurality of facility devices. The distributing includes interpreting a distribution plan (e.g., collecting, aggregating, sending a software aggregation) and/or sending a portion to one or more other facility devices.

The method continues at step 308 where the plurality of facility devices commences utilization of the updated software in accordance with a commencement trigger. The utilizing includes one or more of interpreting a commencement timeframe, receiving an indication that substantially all of the plurality of facility devices are ready to utilize the updated software, receiving a command, and executing the updated software.

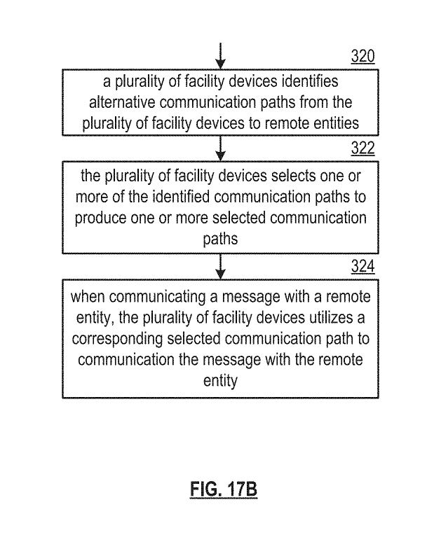

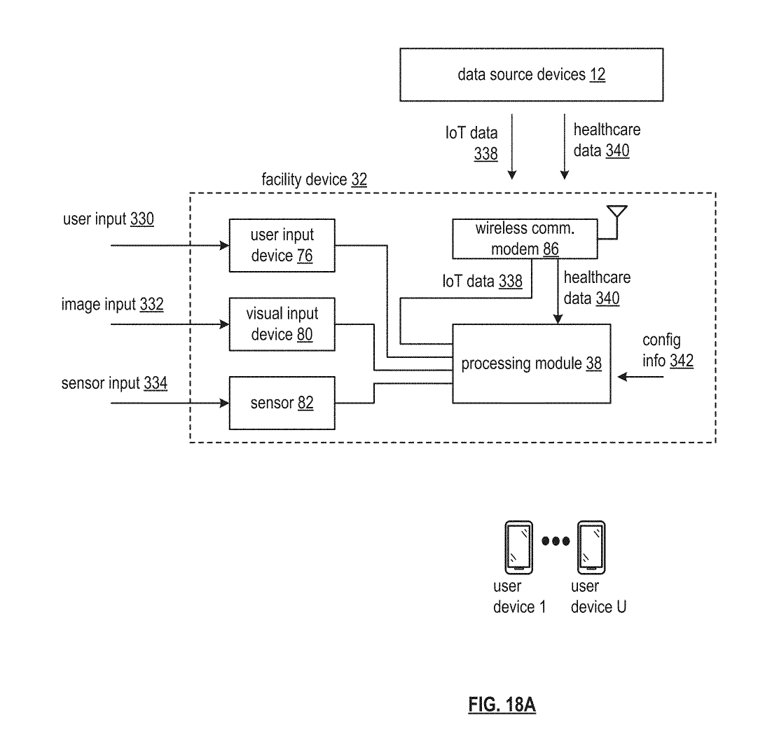

FIG. 17A is a schematic block diagram of another embodiment of a medical device data system (MDDS) that includes the local network 212 of FIG. 12A, a plurality of facility devices 1-N, a plurality of wireless access devices 1-N, the network 24 of FIG. 1, the control server 20 of FIG. 1, and the subscriber devices 18 of FIG. 1. The facility devices 1-N may be implemented utilizing the facility device 32 of FIG. 1. The wireless access devices 1-N may be implemented utilizing the wireless access device 34 of FIG. 1. The control server 20 includes the processing module 38 of FIG. 1 and the database 40 of FIG. 1. The subscriber devices 18 includes the user devices 30 of FIG. 1 and the computing devices 36 of FIG. 1. The MDDS functions to select a communication path.

In an example of operation of the selecting of the communication path, the plurality of facility devices 1-N identifies alternative communication paths (e.g., wireless communication paths 1-N) from the plurality of facility devices to remote entities (e.g., subscriber devices 18, the control server 20, etc.), where the plurality of facility devices have affiliated, via the local network 212, to a common collective of facility devices and have established a favorable trust level with regards to sharing messages for remote communication with the remote entities. The identified includes one or more of initiating a test, interpreting a test result, sharing test results via coordination messages 310, and interpreting historical communication path records.

The plurality of facility devices 1-N selects one or more of the identified communication paths to produce one or more selected pads. The selecting may be based on one or more of cost (e.g., incremental, available under a predetermined purchase plan taking into account a current utilization level), an availability level, a capacity level, a performance level, etc. For example, the plurality of facility devices selects the 2^{nd} communication path when the 2^{nd} communication path from the 2^{nd} facility device to the 2^{nd} wireless access device is associated with a highest level of available data transmission in accordance with a monthly wireless data plan (e.g., lowest-cost path).

When communicating a message with a remote entity, the plurality of facility devices utilizes a corresponding selected communication path to communication a message with the remote entity. For example, the 11^{th} facility device communicates, via the local network 212, an 11^{th} message as a coordination message 310 to the 2^{nd} facility device, the 2^{nd} facility device utilizes the 2^{nd} communication path to send the 2^{nd} message, via the 2^{nd} wireless access device and the network 24, to one or more of the control server 20 and one or more of the subscriber devices 18 as a data message 48 and/or an information message 50.

FIG. 17B is a logic diagram of an embodiment of a method for selecting a communication path. The method includes step 320 where a plurality of facility devices identifies alternative communication paths from the plurality of facility devices to remote entities, where the plurality facility devices have affiliated to a common collective of facility devices and have established a favorable trust level with regards to sharing messages for remote communication with the remote entities. The identifying includes one or more of initiating a test, interpreting a test result, sharing test results via coronation messages, and interpreting historical communication path records with regards to performance levels and availability.

The method continues at step 322 where the plurality of facility devices selects one or more of the identified communication paths to produce one or more selected communication paths. The selecting may be based on one or more of requirements, cost, availability, capacity, and performance. For example, the plurality of facility devices selects a second communication path when the second communication path is associated with a lowest-cost of the alternative communication paths and the requirements indicate lowest-cost is desired. As another example, the plurality of facility devices selects a fifth communication path when the fifth communication path is associated with a highest bandwidth capacity level and a requirement associated with a pending message includes utilization of the highest bandwidth capacity level.

When communicating a message with a remote entity, the method continues at step 324 where the plurality of facility devices utilizes a corresponding select a communication path to communicate the message with the remote entity. For example, a first facility device communicates a message 1 as a coordination message via a local network to a second facility device and the second facility device utilizes a communication path associated with the second facility device to send a message 2 (e.g., that includes the message 1) to a corresponding subscriber device as the remote entity.

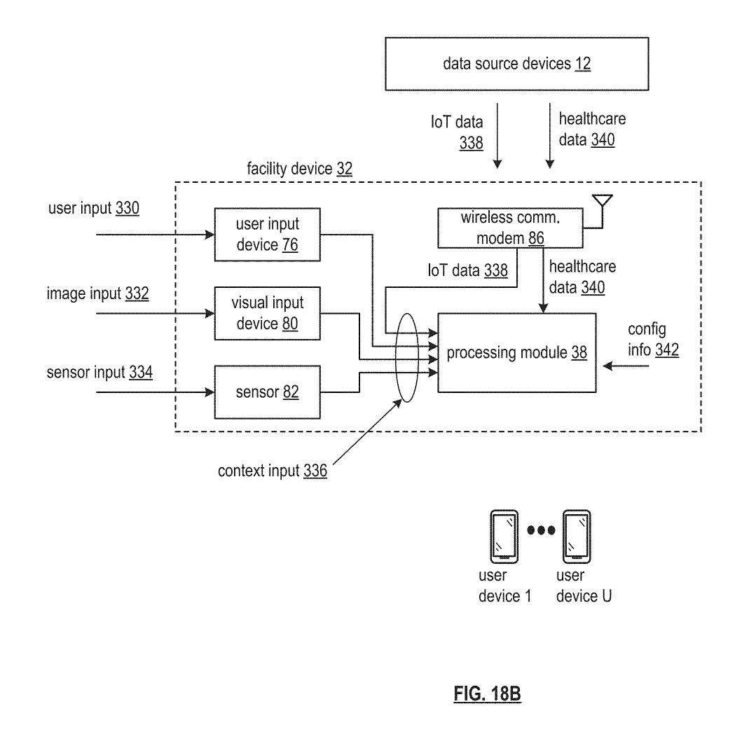

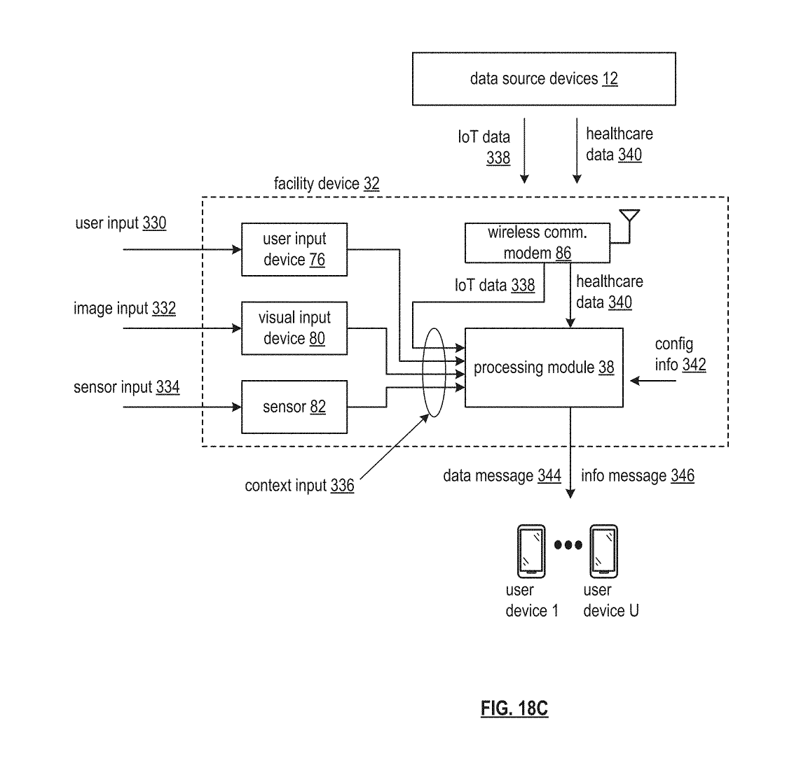

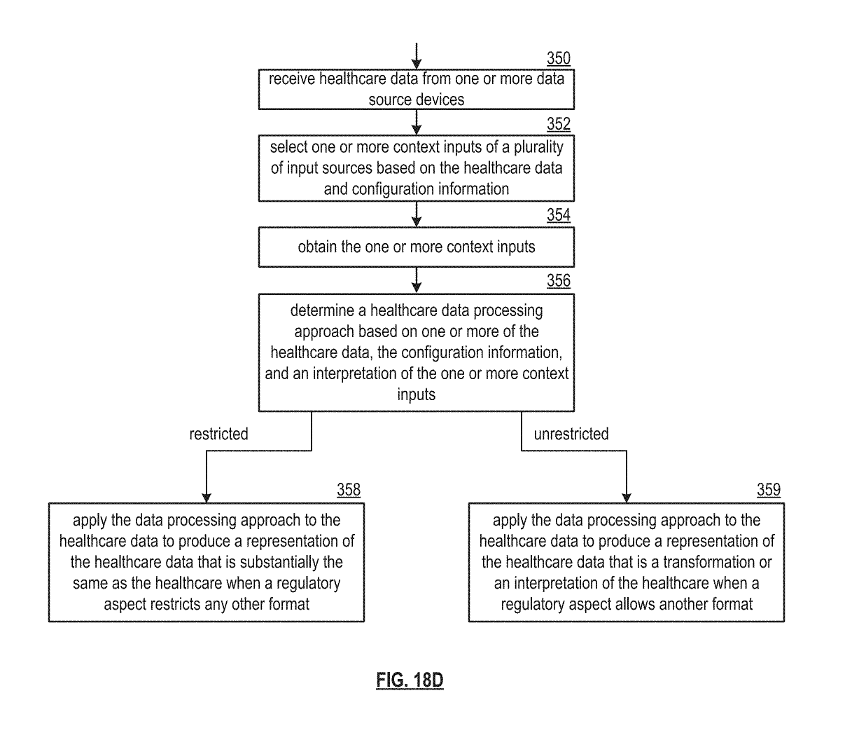

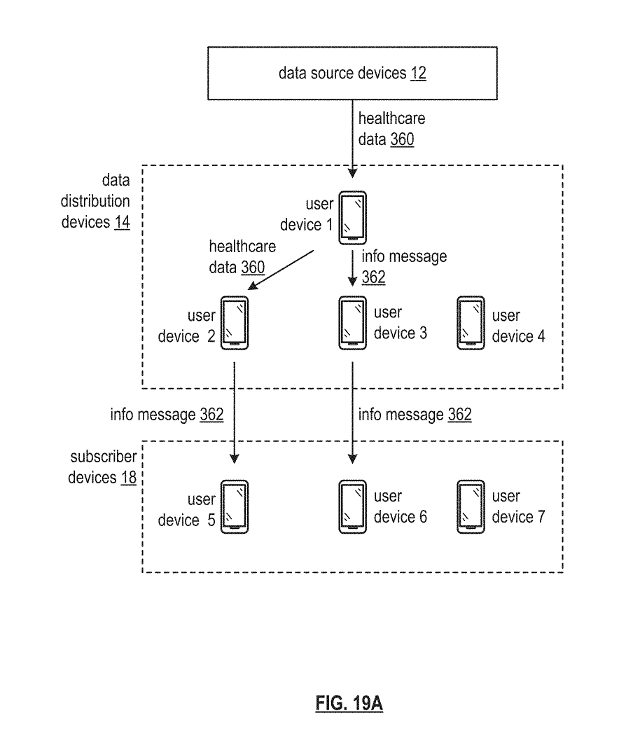

FIGS. 18A-18C are schematic block diagrams of another embodiment of a medical device data system (MDDS) that includes the data source devices 12 of FIG. 1, the facility device 32 of FIG. 1 (e.g., a computing device), and a plurality of user devices 1-U. The facility device 32 includes the user input device 76 of FIG. 3, the visual input device 80 of FIG. 3, the sensor 82 of FIG. 3, the wireless communication modem 86 of FIG. 3, and the processing module 38 of FIG. 3. Each user device may be implemented utilizing the user device 30 of FIG. 1. The MDDS functions to select a healthcare data processing approach.

FIG. 18A illustrates an example of operation of the selecting of the healthcare data processing approach, where the facility device 32 receives healthcare data 340 from one or more data source devices 12. The receiving the healthcare data 340 includes one or more of temporarily storing, in a memory of the facility device 32, first healthcare data sourced by a first data source device of the one or more data source devices, where the first data source device has a favorable affiliation status with the computing device, accessing a memory of at least one of the one or more data source devices to retrieve the healthcare data 340, and receiving a first portion of the healthcare data 340 from the first data source device and receiving a second portion of the healthcare data 340 from a second data source device. As a specific example, the wireless communication modem 86 receives wireless signals from the data source devices 12 that includes the healthcare data 340.

Having received the healthcare data 340, the processing module 38 of the facility device 32 selects one or more context inputs 336 of a plurality of input sources 330-334 based on the healthcare data 340 in accordance with configuration information 342. The configuration information 342 includes configuration information as previously discussed with regards to FIGS. 1-13B. The plurality of input sources includes Internet of things (IoT) data 338, an output of the user input device 76 that receives user input 330, and output of the visual input device 80 that receives image input 332, and an output of sensor 82 that receives sensor input 334.

The selecting the one or more context inputs includes at least one of interpreting a portion of the healthcare data to produce a healthcare data type (e.g., blood oxygen level, blood pressure, etc.), analyzing the healthcare data to produce a healthcare data value (e.g., a blood pressure value set), identifying a healthcare data range based on the healthcare data value (e.g., an expected blood pressure value range), and choosing the one or more context inputs utilizing the configuration information 342 (e.g., retrieved from the memory of the facility device 32), based on one or more of the healthcare data type, the healthcare data value, and the healthcare data range. For example, the processing module 38 selects a user input push button (e.g., of the user input 330) and a room occupancy detector indication (e.g., of IoT data 338) as the selected subset of context inputs 336 when the configuration information 342 associates those context inputs with the received healthcare datatype.

FIG. 18B further illustrates the example of the selecting of the healthcare data processing approach, where, having selected the one or more context inputs, the processing module 38 obtains the one or more context inputs 336 from the selected one or more context inputs. The obtaining the one or more context inputs 336 includes at least one of receiving a first context input from a first selected input source of the plurality of input sources, receiving a second context input from a second selected input source of the plurality of input sources, interpreting a query response, and performing a lookup. As a specific example, the processing module receives an indication of state of a push button via the user input device 76. As another specific example, the processing module receives an indication of room occupancy by interpreting the IoT data 338.

FIG. 18C further illustrates the example of the selecting of the healthcare data processing approach, where, having obtained the one or more context inputs 336, the processing module 38 determines the healthcare data processing approach (e.g., forward raw healthcare data, transform healthcare data to produce display data, interpret healthcare data to produce a summary of the healthcare data, compare healthcare data to a data threshold level to produce an alert, etc.) based on one or more of the healthcare data 340, the configuration information 342, and an interpretation of the one or more context inputs 336. The determining the healthcare data processing approach includes at least one of analyzing the one or more context inputs 336 to produce an interpretation of the one or more context inputs, analyzing a portion of the healthcare data to produce an interpretation of the healthcare data, and mapping the interpretations of the one or more context inputs and of the healthcare data to an associated healthcare data processing approach based on the configuration information 342.

As a specific example of determining the healthcare data processing approach, the processing module 38 interprets the user input switch state as not depressed, interprets the IoT data 338 room occupancy detector as occupied (e.g., by a human associated with the healthcare data 340), interprets the configuration information 342 when the switch has not been depressed and the room is occupied to produce the healthcare data processing approach associated with comparing the healthcare data to the data threshold level to produce the alert.

Having determined the healthcare data processing approach, the processing module 38 applies the data processing approach to the healthcare data 340 to produce a representation of the healthcare data. The producing of the representation of the healthcare data includes identifying one or more steps in accordance with the determined healthcare data processing approach and applying the one or more steps to the healthcare data to produce one or more of a data message 344 and an information message 346 that includes the representation of the healthcare data for transmission to a receiving entity (e.g., one or more user devices).

In a first scenario, the processing module 38 applies the healthcare data processing approach to the healthcare data 340 to produce the representation of the healthcare data, where the representation of the healthcare data is substantially the same as the healthcare data when a regulatory aspect of the configuration information 342 restricts the facility device 32 from representing the healthcare data in a format other than as received from the one or more data source devices 12. For example, the processing module 38 forwards the healthcare data 340 as the data message 344 to one or more user devices when the regulatory aspect restricts the facility device 32 from representing the healthcare data in any other format than as originally received.

In a second scenario, the processing module 38 applies the healthcare data processing approach to the healthcare data 340 to produce the representation of the healthcare data, where the representation of healthcare data the representation of the healthcare data includes at least one of a transformation of the healthcare data and an interpretation of the healthcare data when the regulatory aspect of the configuration information allows the facility device 32 to represent the healthcare data in a format other than as received from the one or more data source devices. As a first instance of the second scenario, the processing module 38 transforms the healthcare data to include reformatting at least a portion of the healthcare data from a received format to another format to produce the information message 346 in accordance with a format requirement of a receiving entity (e.g., a screen of one of the user devices 1-U, a printing format, etc.) when the representation of the healthcare data is to include the transformation of the healthcare data. As a second instance of the second scenario, the processing module 38 interprets the healthcare data to include summarizing at least a portion of the healthcare data to produce the information message 346 when the representation of the healthcare data is to include the interpretation of the healthcare data. As a specific example, the processing module 38 compares the healthcare data 340 to the data threshold level to produce a comparison result and sends the comparison result and a portion of the healthcare data 340 as the information message 346 to the user device 2.

FIG. 18D is a logic diagram of an embodiment of a method for selecting a healthcare data processing approach within a medical device data system. In particular, a method is presented for use in conjunction with one or more functions and features described in conjunction with FIGS. 1-6, 7A-7C, and also FIGS. 18A-18C. The method includes step 350 where a processing module of a computing device (e.g., of a facility device) receives healthcare data from one or more data source devices of the medical device data system. The receiving the healthcare data includes at least one of temporarily storing, in a memory of the computing device, first healthcare data sourced by a first data source device of the one or more data source devices, where the first data source device has a favorable affiliation status with the computing device (e.g., paired, associated, co-located, etc.). The receiving the healthcare data may further include accessing a memory of at least one of the one or more data source devices to retrieve the healthcare data and receiving a first portion of the healthcare data from the first data source device and receiving a second portion of the healthcare data from a second data source device.

The method continues at step 352 where the processing module selects one or more context inputs of a plurality of input sources based on the healthcare data in accordance with configuration information. The selecting the one or more context inputs includes at least one of interpreting a portion of the healthcare data to produce a healthcare data type, analyzing the healthcare data to produce a healthcare data value, identifying a healthcare data range based on the healthcare data value, and choosing the one or more context inputs utilizing the configuration information based on one or more of the healthcare data type, the healthcare data value, and the healthcare data range.

The method continues at step 354 where the processing module obtains the one or more context inputs. The obtaining the one or more context inputs comprises at least one of receiving a first context input from a first selected input source of the plurality of input sources, receiving a second context input from a second selected input source of the plurality of input sources, interpreting a query response, and performing a lookup.

The method continues at step 356 where the processing module determines the healthcare data processing approach based on one or more of the healthcare data, the configuration information, and an interpretation of the one or more context inputs. The determining the healthcare data processing approach includes at least one of analyzing the one or more context inputs to produce an interpretation of the one or more context inputs, analyzing a portion of the healthcare data to produce an interpretation of the healthcare data, and mapping the interpretations of the one or more context inputs and of the healthcare data to an associated healthcare data processing approach based on the configuration information. The configuration information may include a regulatory aspect. When the regulatory aspect is associated with unrestricted processing of the healthcare data, the method branches to step 359. In the regulatory aspect is associated with restricted processing of the healthcare data, the method continues to step 358.

When the processing of the healthcare data is restricted, the method continues at step 358 where the processing module applies the healthcare data processing approach to the healthcare data to produce a representation of the healthcare data, where the representation of the healthcare data is substantially the same as the healthcare data when a regulatory aspect of the configuration information restricts the computing device from representing the healthcare data in a format other than as received from the one or more data source devices.

When the processing the healthcare data is unrestricted, the method continues at step 359 where the processing module applies the healthcare data processing approach to the healthcare data to produce a representation of the healthcare data, where the representation of the healthcare data includes at least one of a transformation of the healthcare data and an interpretation of the healthcare data when a regulatory aspect of the configuration information allows the computing device to represent the healthcare data in a format other than as received from the one or more data source devices. As a first scenario, the processing module transforms the healthcare data to include reformatting at least a portion of the healthcare data from a received format to another format to produce an information message in accordance with a format requirement of a receiving entity when the representation of the healthcare data is to include the transformation of the healthcare data. As a second scenario, the processing module interprets the healthcare data to include summarizing at least a portion of the healthcare data to produce an information message when the representation of the healthcare data is to include the interpretation of the healthcare data.

The method described above in conjunction with the processing module can alternatively be performed by other modules of the medical device data system 10 of FIG. 1 or by other devices. In addition, at least one memory section (e.g., a computer readable memory, a non-transitory computer readable storage medium organized into a first memory element, a second memory element, a third memory element, a fourth element section, a fifth memory element etc.) that stores operational instructions can, when executed by one or more processing modules of one or more computing devices (e.g., one or more servers) of the medical device data system 10, cause the one or more computing devices to perform any or all of the method steps described above.

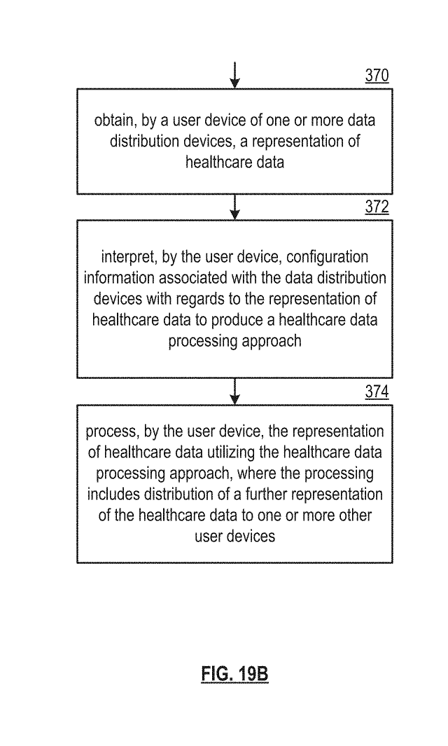

FIG. 19A is a schematic block diagram of another embodiment of a medical device data system (MDDS) that includes the data source devices 12 of FIG. 1, the data distribution devices 14 of FIG. 1, and the subscriber devices 18 of FIG. 1. The data distribution devices 14 includes a plurality of user devices 1-4. The subscriber devices 18 includes a plurality of user devices 5-7. Each user device may be implemented utilizing the user device 30 of FIG. 1. The MDDS functions to process healthcare data when utilizing a plurality of user devices.

In an example of operation of the processing of the healthcare data, a user device of the data distribution devices 14 obtains a representation of healthcare data (e.g., raw healthcare data 360, processed healthcare data). The obtaining includes one or more of receiving from the data source devices 12, receiving from another user device, and receiving in response to a query. For example, the user device 1 receives the healthcare data 360 from the data source devices 12.

Having obtained the representation of the healthcare data, the user device interprets configuration information associated with the data distribution devices 14 with regards to the representation of healthcare data to produce a healthcare data processing approach (e.g., forward raw healthcare data, transform raw healthcare data to produce processed healthcare data, interpret the raw healthcare data to produce an interpretation, etc.). The interpreting includes one or more of accessing the configuration (e.g., performs a lookup, interpreting a query response from another user device), identifying a healthcare datatype, identifying a data source device, and extracting the healthcare data processing approach from the configuration information based on one or more of the healthcare datatype, the data source device, and identity of the user device.

Having produced the healthcare data processing approach, the user device processes the representation of healthcare data utilizing the healthcare data processing approach, where the processing includes distribution of a further representation of the healthcare data to one or more other user devices, where the one or more other user devices includes at least one user device of the data distribution devices 14 and at least one user device of the subscriber devices 18. The processing may further include sending the representation of healthcare data un-altered as healthcare data 360, transforming the representation of the healthcare data into an information message 362 as the further representation of the healthcare data.

Having produced the further representation healthcare data, the user device sends the further representation of the healthcare data to the one or more other user devices. For example, the user device 1 sends the healthcare data 360 to the user device 2 and sends the information message 362 to the user device 3. As a further example, the user device 2 generates the information message 362 based on the received healthcare data 360 from the user device 1 and sends the information message 362 to the user device 5 of the subscriber devices 18 in accordance with the configuration information. As a yet still further example, the user device 3 forwards the information message 362 received from the user device 1 to the user device 6 of the subscriber devices 18 in accordance with the configuration information.

FIG. 19B is a logic diagram of an embodiment of a method for processing healthcare data. The method includes step 370 where a user device of one or more data distribution devices obtains a representation of healthcare data. The obtaining includes at least one of receiving the representation of healthcare data from a data source device, receiving the representation of healthcare data from another user device, receiving a response to a query, and extracting the representation of healthcare data from the response to the query.

The method continues at step 372 where the user device interprets configuration information associated with the data distribution devices with regards to the representation of healthcare data to produce a healthcare data processing approach. The interpreting includes one or more of accessing the configuration information, identifying a healthcare datatype, identified a data source device, and extracting the healthcare data processing approach from the configuration information based on one or more of the healthcare datatype, the data source device, and identity of the user device.

The method continues at step 374 where the user device processes the representation of healthcare data utilizing the healthcare data processing approach, where the processing includes distribution of the further representation of the healthcare data to one or more other user devices, where the one or more other user devices includes at least one user device of the data distribution devices and at least one user device of a plurality of subscriber devices. The processing includes one or more of transforming the representation of the healthcare data into an information message and sending the information message to a second device, or when the representation of healthcare data is in an information message format already, forwarding the information message to another user device, or forwarding raw healthcare data to another user device when the other user device is a data distribution device.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for selecting a healthcare data processing approach within a medical device data system, the method comprises:
receiving, by a computing device of the medical device data system, healthcare data from one or more data source devices of the medical device data system;
selecting, by the computing device, one or more context inputs of a plurality of input sources based on the healthcare data in accordance with configuration information;
obtaining, by the computing device, the one or more context inputs; and
determining, by the computing device, the healthcare data processing approach based on one or more of the healthcare data, the configuration information, and an interpretation of the one or more context inputs.

2. The method of claim 1 further comprises:
applying, by the computing device, the healthcare data processing approach to the healthcare data to produce a representation of the healthcare data, wherein the representation of the healthcare data is substantially the same as the healthcare data when a regulatory aspect of the configuration information restricts the computing device from representing the healthcare data in a format other than as received from the one or more data source devices.

3. The method of claim 1 further comprises:
applying, by the computing device, the healthcare data processing approach to the healthcare data to produce a representation of the healthcare data, wherein the representation of the healthcare data includes at least one of a transformation of the healthcare data and an interpretation of the healthcare data when a regulatory aspect of the configuration information allows the computing device to represent the healthcare data in a format other than as received from the one or more data source devices.

4. The method of claim 3 further comprises:
transforming, by the computing device, the healthcare data to include reformatting at least a portion of the healthcare data from a received format to another format to produce an information message in accordance with a format requirement of a receiving entity when the representation of the healthcare data is to include the transformation of the healthcare data.

5. The method of claim 3 further comprises:
interpreting, by the computing device, the healthcare data to include summarizing at least a portion of the healthcare data to produce an information message when the representation of the healthcare data is to include the interpretation of the healthcare data.

6. The method of claim 1, wherein the receiving the healthcare data comprises at least one of:
temporarily storing, in a memory of the computing device, first healthcare data sourced by a first data source device of the one or more data source devices, wherein the first data source device has a favorable affiliation status with the computing device;
accessing a memory of at least one of the one or more data source devices to retrieve the healthcare data; and
receiving a first portion of the healthcare data from the first data source device and receiving a second portion of the healthcare data from a second data source device.

7. The method of claim 1, wherein the selecting the one or more context inputs comprises at least one of:
interpreting a portion of the healthcare data to produce a healthcare data type;
analyzing the healthcare data to produce a healthcare data value;
identifying a healthcare data range based on the healthcare data value; and
choosing the one or more context inputs utilizing the configuration information based on one or more of the healthcare data type, the healthcare data value, and the healthcare data range.

8. The method of claim 1, wherein the obtaining the one or more context inputs comprises at least one of:
receiving a first context input from a first selected input source of the plurality of input sources;
receiving a second context input from a second selected input source of the plurality of input sources;
interpreting a query response; and
performing a lookup.

9. The method of claim 1, wherein the determining the healthcare data processing approach comprises at least one of:
analyzing the one or more context inputs to produce an interpretation of the one or more context inputs;
analyzing a portion of the healthcare data to produce an interpretation of the healthcare data; and
mapping the interpretations of the one or more context inputs and of the healthcare data to an associated healthcare data processing approach based on the configuration information.

10. A non-transitory computer readable memory comprises:
a first memory element that stores operational instructions that, when executed by a computing device of a medical device data system, causes the computing device to:
receive healthcare data from one or more data source devices of the medical device data system;
a second memory element that stores operational instructions that, when executed by the computing device, causes the computing device to:
select one or more context inputs of a plurality of input sources based on the healthcare data in accordance with configuration information;
a third memory element that stores operational instructions that, when executed by the computing device, causes the computing device to:
obtaining the one or more context inputs; and
a fourth memory element that stores operational instructions that, when executed by the computing device, causes the computing device to:
determine a healthcare data processing approach based on one or more of the healthcare data, the configuration information, and an interpretation of the one or more context inputs.

11. The computer readable memory of claim 10 further comprises:
a fifth memory element that stores operational instructions that, when executed by the computing device, causes the computing device to:
apply the healthcare data processing approach to the healthcare data to produce a representation of the healthcare data, wherein the representation of the healthcare data is substantially the same as the healthcare data when a regulatory aspect of the configuration information restricts the computing device from representing the healthcare data in a format other than as received from the one or more data source devices.

12. The computer readable memory of claim 10 further comprises:
a fifth memory element that stores operational instructions that, when executed by the computing device, causes the computing device to:
apply the healthcare data processing approach to the healthcare data to produce a representation of the healthcare data, wherein the representation of the healthcare data includes at least one of a transformation of the healthcare data and an interpretation of the healthcare data when a regulatory aspect of the configuration information allows the computing device to represent the healthcare data in a format other than as received from the one or more data source devices.

13. The computer readable memory of claim 12 further comprises:
the fifth memory element further stores operational instructions that, when executed by the computing device, causes the computing device to:
transform the healthcare data to include reformatting at least a portion of the healthcare data from a received format to another format to produce an information message in accordance with a format requirement of a receiving entity when the representation of the healthcare data is to include the transformation of the healthcare data.

14. The computer readable memory of claim 12 further comprises:
the fifth memory element further stores operational instructions that, when executed by the computing device, causes the computing device to:
interpret the healthcare data to include summarizing at least a portion of the healthcare data to produce an information message when the representation of the healthcare data is to include the interpretation of the healthcare data.

15. The computer readable memory of claim 10 further comprises:
the first memory element further stores operational instructions that, when executed by the computing device, causes the computing device to receive the healthcare data by at least one of:
temporarily storing, in a memory of the computing device, first healthcare data sourced by a first data source device of the one or more data source devices, wherein the first data source device has a favorable affiliation status with the computing device;
accessing a memory of at least one of the one or more data source devices to retrieve the healthcare data; and
receiving a first portion of the healthcare data from the first data source device and receiving a second portion of the healthcare data from a second data source device.

16. The computer readable memory of claim 10 further comprises:
the second memory element further stores operational instructions that, when executed by the computing device, causes the computing device to select the one or more context inputs by at least one of:
interpreting a portion of the healthcare data to produce a healthcare data type;
analyzing the healthcare data to produce a healthcare data value;
identifying a healthcare data range based on the healthcare data value; and
choosing the one or more context inputs utilizing the configuration information based on one or more of the healthcare data type, the healthcare data value, and the healthcare data range.

17. The computer readable memory of claim 10 further comprises:
the third memory element further stores operational instructions that, when executed by the computing device, causes the computing device to obtain the one or more context inputs by at least one of:
receiving a first context input from a first selected input source of the plurality of input sources;
receiving a second context input from a second selected input source of the plurality of input sources;
interpreting a query response; and
performing a lookup.

18. The computer readable memory of claim 10 further comprises:
the fourth memory element further stores operational instructions that, when executed by the computing device, causes the computing device to determine the healthcare data processing approach by at least one of:
analyzing the one or more context inputs to produce an interpretation of the one or more context inputs;
analyzing a portion of the healthcare data to produce an interpretation of the healthcare data; and
mapping the interpretations of the one or more context inputs and of the healthcare data to an associated healthcare data processing approach based on the configuration information.
